(19) United States
(12) Patent Application Publication
(10) Pub. No.: US 2024/0157725 A1
(43) Pub. Date: May 16, 2024

(54) WHEELS, TRACKS SYSTEMS, AND WHEEL ASSEMBLIES

(71) Applicant: SOUCY INTERNATIONAL INC., Drummondville (CA)

(72) Inventors: Etienne LEBLANC, Becancour (CA); Jonathan FRENETTE-MARCOUX, Drummondville (CA)

(21) Appl. No.: 18/508,733

(22) Filed: Nov. 14, 2023

Related U.S. Application Data
(60) Provisional application No. 63/425,103, filed on Nov. 14, 2022.

(51) Int. Cl. B60B 9/26; B62D 55/10; B62D 55/14

(52) U.S. Cl. CPC B60B 9/26; B62D 55/10; B62D 55/14

(57) ABSTRACT

A compliant wheel includes a hub portion and a resilient portion. The hub portion defines an axis and a longitudinal plane. The resilient portion extends radially from the hub portion, and includes a plurality of elements, and a plurality of fold lines. A first element of the plurality of elements and a second element of the plurality of elements are connected by one of the plurality of fold lines. The one of the plurality of fold lines defines a bend axis, and the first element is configured to resiliently move relative to the second element about the bend axis.

### CROSS-REFERENCE TO RELATED APPLICATION

This application claims the benefit of and priority to U.S. provisional patent application No. 63/425,103, filed on Nov. 14, 2022; the content of all of which is herein incorporated in entirety by reference.

### FIELD OF TECHNOLOGY

The present technology generally relates to wheels and wheel assemblies comprising them as well as to track systems comprising such wheel assemblies.

### BACKGROUND

Certain vehicles, such as, for example, agricultural vehicles (e.g., harvesters, combines, tractors, etc.) and construction vehicles (e.g., bulldozers, front-end loaders, etc.), are used to perform work on ground surfaces that are soft, slippery and/or uneven (e.g., soil, mud, sand, ice, snow, etc.).

Conventionally, such vehicles have large wheels with tires on them to move the vehicle along the ground surface. Under certain conditions, such tires may have poor traction on some ground surfaces and, as these vehicles are generally heavy, the tires may compact the ground surface in an undesirable way owing to the weight of the vehicle. As an example, when the vehicle is an agricultural vehicle, the tires may compact the soil in such a way as to undesirably inhibit the growth of crops. In order to reduce the aforementioned drawbacks, to increase traction and to distribute the weight of the vehicle over a larger area on the ground surface, track systems were developed to be used in place of at least some of the wheels and tires on the vehicles.

The use of track systems in place of wheels and tires, however, does itself present some inconveniences. One of the drawbacks of conventional track systems is that they tend to decrease the ride comfort experienced by the operator of the vehicle because the air cushion provided by a tire (between each wheel and tire) is not present in such track systems. Thus, vehicles equipped with such track systems in place of wheels and tires are typically subjected to an increased amount of vibration and vertical displacement when driven on uneven surfaces (as compared with the same vehicle having a wheel and tire), because the lack of an air cushion means there is no damping that would otherwise be provided if there were. In addition to potential increased operator discomfort, these vibrations and vertical displacements can potentially lead to premature wear of the vehicle, its component parts, and/or its attached accessories and equipment. Under certain conditions and at certain speeds, vertical displacements and vibrations transferred to the chassis can be so significant that it may be required to slow down the vehicle.

While some solutions have been provided to ameliorate some of the drawbacks of conventional track systems, continued improvement in this area is desirable.

### SUMMARY

According to one aspect of the present technology, there is provided a compliant wheel according to an aspect of the present technology. The compliant wheel includes a hub portion and a resilient portion. The hub portion defines an axis and a longitudinal plane. The resilient portion extends, which extends radially from the hub portion, includes a plurality of elements, and a plurality of fold lines. A first element of the plurality of elements and a second element of the plurality of elements are connected by one of the plurality of fold lines, the one of the plurality of fold lines defining a bend axis. The first element is configured to resiliently move relative to the second element about the bend axis.

In some embodiments, a force applied to the compliant wheel is distributed to at least some of the plurality of elements according to a pre-determined profile of resiliency.

In some embodiments, one of plurality of elements has a first element thickness, an other one of the plurality of elements has a second element thickness, the first element thickness being different from the second element thickness.

In some embodiments, the one of the plurality of elements is the first element, and the other one of the plurality of elements is the second element.

In some embodiments, one of the plurality of elements has an element thickness, one of the plurality of fold lines has a fold line thickness, the element thickness being different from the fold line thickness.

In some embodiments, the element thickness is greater than the fold line thickness.

In some embodiments, an other one of the plurality of fold lines has an other fold line thickness, the other fold line thickness being different from the fold line thickness.

In some embodiments, at least one of the element thickness and the fold line thickness modulates a profile of resiliency of the resilient portion.

In some embodiments, the plurality of fold lines includes a plurality of radial fold lines and a plurality of tangent fold lines.

In some embodiments, at least one of the plurality of fold lines extends at least partially radially and partially tangentially.

In some embodiments, a number of radial fold lines modulates a profile of resiliency of the resilient portion.

In some embodiments, a number of tangent fold lines modulates a profile of resiliency of the resilient portion.

In some embodiments, the plurality of elements defines at least one apex and at least one depression, the at least one apex and the at least one depression being connected by at least one of a radial fold line of the plurality of radial fold lines, and a tangent fold line of the plurality of tangent fold lines.

In some embodiments, the at least one apex and the at least one depression are connected by the radial fold line, and a distance between the at least one apex and the at least one depression modulates a profile of resiliency of the resilient portion.

In some embodiments, the at least one apex and the at least one depression are connected by the tangent fold line, and a distance between the at least one apex and the at least one depression modulates a profile of resiliency of the resilient portion.

In some embodiments, the plurality of elements includes peripheral elements forming a peripheral surface of the compliant wheel.

In some embodiments, the peripheral elements include a first peripheral element and a second peripheral element adjacent to the first peripheral element, the first and second peripheral elements extending at an angle to the longitudinal plane.

In some embodiments, the first and second peripheral elements are disposed in a zig-zag configuration.

In some embodiments, the first and second peripheral elements are disposed in a chevron-like configuration.

In some embodiments, the compliant wheel further includes a flexible rim portion connected to the resilient portion.

In some embodiments, the flexible rim portion is integral with the resilient portion.

In some embodiments, the flexible rim portion in connected to the resilient portion by one of: overmolding, adhesive, fasteners and interlockers.

In some embodiments, the flexible rim portion is made of a resilient material.

In some embodiments, the resilient material is made of rubber, foam, plastic, and metal.

In some embodiments, the flexible rim portion modulates a profile of resiliency of the resilient portion.

In some embodiments, at least one of a thickness of the flexible rim portion and a width of the flexible rime portion modulates the profile of resiliency of the resilient portion.

In some embodiments, in a resting state, the compliant wheel has a first profile perimeter. In response to a force being applied to the compliant wheel, the compliant wheel deforms to a deformed state, in which at least some of the plurality of elements move about corresponding bend axes, and in which the compliant wheel has a second profile perimeter, the second profile perimeter being substantially equal to the first profile perimeter.

In some embodiments, a ratio of deformation of the second profile perimeter over the first profile perimeter is between 0.60 and 1.0.

In some embodiments, a ratio of deformation of the second profile perimeter over the first profile perimeter is between 0.60 and 1.2.

In some embodiments, the resilient portion defines a plurality of equal sections, each one of the plurality of sections comprising at least one peripheral segment. In the resting state, a length of each peripheral segment of the plurality of peripheral segments is substantially similar, and in the deformed state, a length of at least one of the peripheral segments varies.

In some embodiments, in the deformed state, at least one of the peripheral segment is generally linear.

In some embodiments, the first element extends along a first plane, the second element extends along a second plane, and the second plane is at an angle relative to the first plane.

In some embodiments, at least some of the plurality of elements form an inner profile having inner apexes and inner depressions, and at least some of the plurality of elements form an outer profile having outer apexes and outer depressions.

In some embodiments, at least one of the inner and outer profiles protrudes axially from the longitudinal plane.

In some embodiments, the inner profile and the outer profile are one of: asymmetrical relative to the longitudinal plane and symmetrical relative to the longitudinal plane.

In some embodiments, at least one of the plurality of elements has a shape formed of at least three sides.

In some embodiments, the shape is one of a triangle, a rectangle, a diamond, a pentagon, and a hexagon.

In some embodiments, the first element has a first shape, the second element has a second shape, and the first and second shape are different from one another.

In some embodiments, the shape of the first and second elements modulates a profile of resiliency of the resilient portion.

In some embodiments, at least some of the plurality of elements are arranged in a pyramidal clusters.

In some embodiments, the resilient portion is made of a polymeric material.

In some embodiments, the polymeric material is one of ultra-high molecular weight polyethylene, high-density polyethylene, polypropylene, and polyurethane.

In some embodiments, the resilient portion is made by an additive manufacturing process.

In some embodiments, the additive manufacturing process is one molding, casting, injection molding, and 3D printing.

In some embodiments, the resilient portion is made of a metallic material.

In some embodiments, the resilient portion is made of spring steel.

In some embodiments, the resilient portion is made of a composite material.

In some embodiments, the composite material is one of resin reinforced matrix with carbon fiber, and fiberglass.

In some embodiments, the resilient portion and the hub portion are integral.

In some embodiments, the resilient portion is made of one integral member.

In some embodiments, the resilient portion is pivotally connected to the hub portion.

According to another aspect of the present technology, there is provided a track system comprising a frame, a plurality of wheel assemblies rotationally connected to the frame, and an endless track surrounding the frame and the plurality of wheel assemblies. At least one wheel assembly of the plurality of wheel assemblies includes a compliant wheel according to the above aspect or the above aspect and one or more of the above embodiments.

In some embodiments, the resilient portion is an assembly.

In some embodiments, the first element and the second element are connected in a hinge configuration about the one of the plurality of fold lines.

In some embodiments, the first and second elements are connected by a resilient hinge.

According to another aspect of the present technology, there is provided a deformable wheel comprising: a hub portion and a resilient portion. The hub portion defines an axis and a longitudinal center plane. The resilient portion extends radially from the hub portion, and includes a plurality of elements arranged in a mesh pattern. Each one of the plurality of elements has a polygonal shape defining a plurality of vertices and a plurality of edges. A first element and a second element are connected by one of the plurality of edges, the one of the plurality of edges defining a bend axis. The first element is configured to resiliently move relative to the second element about the bend axis.

In some embodiments, the resilient portion includes an inner side and an outer side. The inner side defines a first circle having a first diameter and defining a first plane axially spaced from the longitudinal center plane by a first distance, and a second circle having a second diameter and defining a second plane axially spaced from the longitudinal center plane by a second distance. The outer side defines a third circle having a third diameter and defining a third plane axially spaced from the longitudinal center plane by a third distance, and a fourth circle having a fourth diameter and defining a fourth plane axially spaced from the longitudinal center plane by a fourth distance. The vertices of the first element are on at least three of the first, second, third and fourth circles.

In some embodiments, at least one of the second diameter is greater than the first diameter; and the third diameter is greater than the fourth diameter.

In some embodiments, at least one of the second distance is greater than the first distance, and the third distance is greater than the fourth distance.

In some embodiments, at least one of the first diameter is equal to the third diameter, the second diameter is equal to the fourth diameter, the first distance is equal to the third distance, and the second distance is equal to the fourth distance.

In some embodiments, at least one of the plurality of elements has a triangular shape.

In some embodiments, at least some of the plurality of elements are arranged in a pyramidal cluster.

In some embodiments, a base of the pyramidal cluster is defined by at least three vertices of adjacent elements of the plurality of elements.

In some embodiments, the at least three vertices are disposed on one of the inner and outer sides, and an apex is disposed on an another one of the inner and outer side.

In some embodiments, the base is open.

In some embodiments, the inner side defines a fifth circle having a fifth diameter and defining a fifth plane axially spaced from the longitudinal center plane by a fifth distance, and the outer side defines a sixth circle having a sixth diameter and defining a sixth plane axially spaced from the longitudinal center plane by a sixth distance.

In some embodiments, at least one of the fifth diameter is greater than the second diameter, and the sixth diameter is greater than the fourth diameter.

In some embodiments, the resilient member includes a first resilient section extending from the hub portion to the first and third circles and comprising a first set of elements amongst the plurality of elements, a second resilient section extending from the first and third circles to the second and fourth circles and comprising a second set of elements amongst the plurality of elements, connected to the first set of elements, and a third resilient section extending from the second and fourth circles to the fifth and sixth circles and comprising a third set of elements amongst the plurality of elements, connected to the first set of elements.

In some embodiments, at least one of the fifth and sixth circles is a peripheral circle.

In some embodiments, the first and second sets of elements form a first pyramidal cluster, and the second and third sets of elements form a second pyramidal cluster.

In some embodiments, a first base of the first pyramidal cluster is defined by at least three vertices of adjacent elements of the first set of elements, and a second base of the second pyramidal cluster is defined by at least two vertices of the first base.

According to another aspect of the present technology, there is provided a wheel comprising a rigid hub portion, and a resilient portion that extends radially from the rigid hub portion. The resilient portion includes a plurality of elements and a plurality of fold lines. A first element of the plurality of elements and a second element of the plurality of elements are connected to one another by one of the plurality of fold lines, the one of the plurality of fold lines defining a rotation axis. The first element is configured to move relative to the second element about the rotation axis.

In some embodiments, the wheel further includes a flexible rim portion connected to the resilient portion.

In some embodiments, the plurality of elements includes at least one of a triangular element, a rectangular element, a pentagonal element, and a hexagonal element.

In some embodiments, the first one amongst the plurality of elements has a first flat surface and the second one amongst the plurality of elements has a second flat surface, the first flat surface and the second flat surface sharing a common edge, the common edge corresponding to the respective one of the plurality of fold lines.

In some embodiments, the first one amongst the plurality of elements has a third flat surface and the second one amongst the plurality of elements has a fourth flat surface, the third flat surface extending along a first plane and the fourth flat surface extending along a second plane, the first plane being at an angle relative to the second plane.

In some embodiments, the first one and the second one amongst the plurality of elements are connected in a hinge configuration at the respective one of the plurality of folding lines.

In some embodiments, in a first configuration of the wheel, the wheel has a first perimeter, and in response to a force being applied to the wheel, the wheel moves to a second configuration. In the second configuration, at least some of the plurality of elements move about respective rotation axes, and the wheel has a second perimeter substantially equal to the first perimeter.

In some embodiments, the plurality elements include peripheral elements disposed in a zig-zag configuration.

In some embodiments, a first element amongst the peripheral elements has a first peripheral edge, a second element amongst the peripheral element has a second peripheral edge, the first and second peripheral edges extending at an angle relative to a longitudinal center plane of the wheel.

In some embodiments, the resilient member is integrally formed.

In some embodiments, the resilient member is made of a plastic material.

According to another aspect of the present technology, there is provided a computer-implemented method for generating a 3D representation of a wheel. The method is executable by a processor, and includes generating, by the processor, a first structure in 3D space, the first structure being a 3D representation of a hub portion of the wheel, generating, by the processor, a plurality of circular structures relative to the first structure, the plurality of circular structures being coaxial with the first structure and being laterally offset from the first structure, generating, by the processor, a plurality of vertices located on the plurality of circular structures. The plurality of vertices is connected by respective edges and define a plurality of surface elements. The plurality of surface elements is a 3D representation of a radial member of the wheel. The method also includes causing, by the processor, manufacture of the wheel based on the 3D representation of the hub portion and the 3D representation of the radial member.

### FIGURES

For a better understanding of the present technology, as well as other aspects and further features thereof, reference is made to the following description which is to be used in conjunction with the accompanying figures, where:

FIG. 1 is a side elevation view of a track system having a wheel according to an embodiment of the present technology;

FIG. 2A is a perspective view of the track system of FIG. 1, with an endless track thereof being omitted;

FIG. 2B is a close-up of a rear idler wheel assembly of the track system of FIG. 1;

FIG. 3A is a perspective view taken from an outer side of a compliant wheel according to an embodiment of the present technology;

FIG. 3B is a perspective view taken from an inner side of the compliant wheel of FIG. 3A;

FIG. 3C is a side elevation view of the compliant wheel of FIG. 3A;

FIG. 3D is a front elevation view of the compliant wheel of FIG. 3A;

FIG. 4A is a schematic depiction of two elements and a fold line of a resilient portion of the compliant wheel of FIG. 3A;

FIG. 4B a schematic depiction of the two elements and the fold line of FIG. 4A;

FIG. 5A is a schematic depiction of the two elements and the fold line according to an other embodiment of the present technology;

FIG. 5B is a schematic depiction of the two elements and the fold line according to an other embodiment of the present technology;

FIG. 5C is a schematic depiction of the two elements and the fold line according to an other embodiment of the present technology;

FIG. 6 is a close-up of some elements and some fold lines of the wheel of FIG. 3A;

FIG. 7 is a front elevation view of an alternative embodiment of the compliant wheel of FIG. 3A;

FIG. 8A is a perspective view taken from an outer side of a compliant wheel according to an embodiment of the present technology;

FIG. 8B is a perspective view taken from an inner side of the compliant wheel of FIG. 8A;

FIG. 8C is a side elevation view of the compliant wheel of FIG. 8A;

FIG. 8D is a front elevation view of the compliant wheel of FIG. 8A;

FIG. 9A is a perspective view taken from an outer side of a compliant wheel according to an embodiment of the present technology;

FIG. 9B is a perspective view taken from an inner side of the compliant wheel of FIG. 9A;

FIG. 9C is a side elevation view of the compliant wheel of FIG. 9A;

FIG. 9D is a front elevation view of the compliant wheel of FIG. 9A;

FIG. 10A is a perspective view taken from an outer side of a compliant wheel according to an embodiment of the present technology;

FIG. 10B is a perspective view taken from an inner side of the compliant wheel of FIG. 10A;

FIG. 10C is a side elevation view of the compliant wheel of FIG. 10A;

FIG. 10D is a front elevation view of the compliant wheel of FIG. 10A;

FIG. 11A is a perspective view taken from an outer side of a compliant wheel according to an embodiment of the present technology;

FIG. 11B is a perspective view taken from an inner side of the compliant wheel of FIG. 11A;

FIG. 11C is a side elevation view of the compliant wheel of FIG. 11A;

FIG. 11D is a front elevation view of the compliant wheel of FIG. 11A;

FIG. 12A is a perspective view taken from an outer side of a compliant wheel according to an embodiment of the present technology;

FIG. 12B is a perspective view taken from an inner side of the compliant wheel of Figure A;

FIG. 12C is a side elevation view of the compliant wheel of Figure A;

FIG. 12D is a front elevation view of the compliant wheel of Figure A;

FIG. 12E is a front elevation view of a compliant wheel according to an embodiment of the present technology;

FIG. 13A is a perspective view taken from an outer side of a compliant wheel according to an embodiment of the present technology;

FIG. 13B is a perspective view taken from an inner side of the compliant wheel of FIG. 13A;

FIG. 13C is a side elevation view of the compliant wheel of FIG. 13A;

FIG. 13D is a front elevation view of the compliant wheel of FIG. 13A;

FIG. 14A is a perspective view of a compliant wheel according to an embodiment of the present technology;

FIG. 14B is a set of components for a kit for the compliant wheel of FIG. 14A;

FIG. 15A is a perspective view taken from an outer side of a compliant wheel according to an embodiment of the present technology;

FIG. 15B is a perspective view taken from an inner side of the compliant wheel of FIG. 15A;

FIG. 15C is a side elevation view of the compliant wheel of FIG. 15A;

FIG. 15D is a front elevation view of the compliant wheel of FIG. 15A;

FIG. 16A is a perspective view of a robot with compliant wheels according to an embodiment of the present technology;

FIG. 16B is a perspective view of the compliant wheel of FIG. 16A;

FIG. 17A is schematic view of a conventional wheel in an unloaded state;

FIG. 17B is a schematic view of the conventional wheel of FIG. 17A in a first loaded state;

FIG. 17C is a schematic view of the conventional wheel of FIG. 17A in a second loaded state;

FIG. 18A is schematic view of a compliant wheel according to an embodiment of the present technology in an unloaded state;

FIG. 18B is a schematic view of the compliant wheel of FIG. 18A in a first loaded state;

FIG. 18C is a schematic view of the compliant wheel of FIG. 18A in a second loaded state;

FIG. 19A is a schematic view of a compliant wheel according to an embodiment of the present technology in an unloaded state;

FIG. 19B is a schematic view of the compliant wheel of FIG. 19A in a loaded state;

FIG. 20A is a schematic plan view of a footprint of a compliant wheel according to an embodiment of the present technology in an unloaded state;

FIG. 20B is a schematic plan view of the footprint of FIG. 20A in a loaded state

FIG. 21 is a schematic representation of a computer system as contemplated in at least some non-limiting embodiments of the present technology;

FIGS. 22A, 22B, 23A, 23B, 24A and 24B a are a schematic representation of geometrical structures generated by the computer system during a design process of FIG. 21;

FIG. 25 is a visual output of the computer system of FIG. 21 during the design process;

FIG. 26 is a table depicting a plurality of pyramidal clusters;

FIG. 27A is schematic depiction of orbits of a symmetrical compliant wheel;

FIG. 27A is schematic depiction of orbits of a asymmetrical compliant wheel;

FIG. 28 is a schematic illustration of data items stored in a storage of the computer device of FIG. 21 in accordance with some non-limiting embodiments of the present technology; and

FIG. 29 is a flowchart of a method executable by the computer device of FIG. 21 according to an embodiment of the present technology.

### DESCRIPTION

In some embodiments of the present technology, there is provided a compliant wheel that comprises a hub portion, and a resilient portion extending radially from the hub portion. In some embodiments, the compliant wheel may further comprise a flexible rim portion. The resilient portion includes a plurality of elements and a plurality of fold lines, such that a first element is configured to resiliently move relative to a second element about a corresponding bend axis defined by a corresponding folding line. The resilient portion is configured to be resiliently deformable when the compliant wheel is in use due to the relative movement of elements about respective bend axes.

Broadly, the compliant wheel has a first profile perimeter at rest. In response to a force being applied to the compliant wheel, such as when a track system upon which is mounted the compliant wheel is overcoming an obstacle, the resilient portion of the compliant wheel resiliently deforms, thereby absorbing at least some of the force applied thereon. In this deformed state, at least some of the plurality of elements move with respect to one another. While deformed, the compliant wheel has a second profile perimeter that is substantially the same as the first profile perimeter. For example, at rest, the compliant wheel may have circular profile shape and when deformed the compliant wheel may have a D-like profile shape, with some instances, a flat portion of the “D” being where the force is applied. However, due to, inter alia, the cooperation of the plurality of elements and the plurality of fold lines, the profile perimeter of the compliant wheel may remain substantially the same, as opposed to conventional wheels. It should be noted that although the profile perimeter of the compliant wheel may remain substantially the same during resilient and temporary deformation, the width of the compliant wheel may change due to cooperation of the plurality of elements and the plurality of fold lines. Developers of the present technology have realized that wheels that are able to maintain substantially the same profile perimeter at rest and during operation may aid in maintaining tension of an endless track when used as a wheel of a track system. Maintaining tension of the endless track may reduce wear of the endless track and/or reduce the likelihood of “detracking” of the endless track from the track system.

It should be noted that a compliant wheel may be provided in a variety of configurations. At least some of these configurations are depicted in the accompanying Figures. Other designs and configurations are contemplated. Developers of the present technology have realized that different configurations of the compliant wheel may result in compliant wheels having different profiles of resiliency. Broadly speaking, the profile of resiliency of a given compliant wheel is a property indicative of how resilient (or rigid) the given compliant wheel is when a force is applied thereon. For example, a first compliant wheel with a first configuration may have a first profile of resiliency, and a second compliant wheel with a second configuration may have a second profile of resiliency, such that the first compliant wheel may be more resilient than the second compliant wheel when a same force is applied on the first and second compliant wheels.

As it will become apparent from the description herein further below, one or more resiliency parameters can be used to provide a compliant wheel with a desired profile of resiliency. As such, a compliant wheel may be more (or less) resilient depending on, inter alia, a selection of one or more resiliency parameters (and/or combination thereof) during the designing process of the compliant wheel.

In some embodiments of the present technology, a given compliant wheel may comprise a plurality of resilience “zones” having distinct resilience profiles. In these embodiments, the resilience profile may not be uniform in a radial direction away from the hub portion of the given compliant wheel, as opposed to some existing solutions. It can be said that a given compliant wheel may have an inner zone and an outer zone, and where one of the inner zone and the outer zone is more resilient than the other one of the inner zone and the outer zone. A given compliant wheel may comprise more than one resilience zones extending about the hub portion and radially away from the hub portion.

### Track System

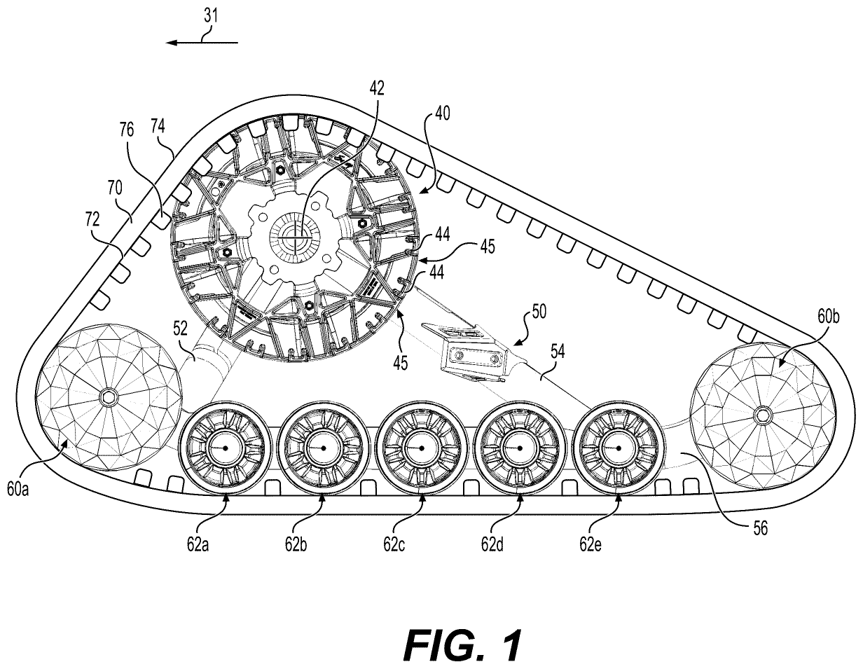

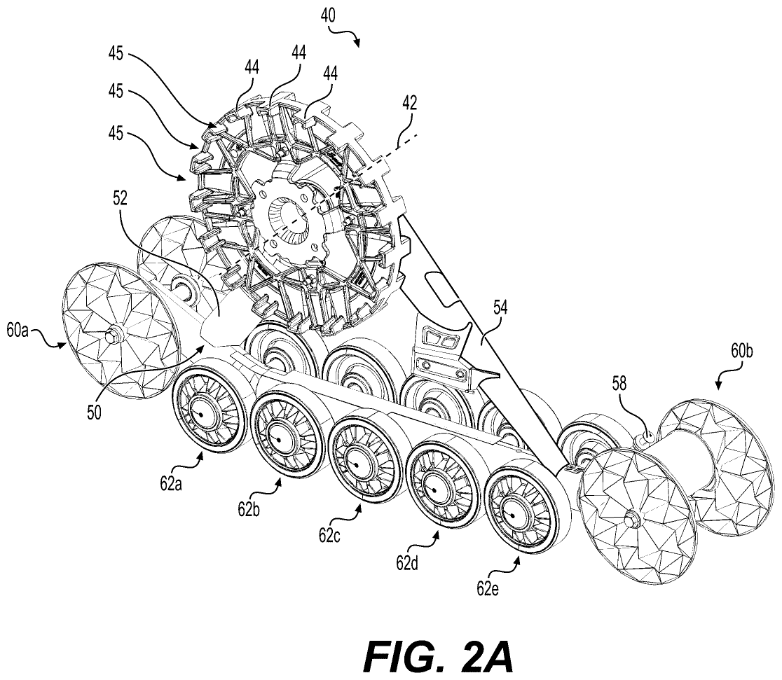

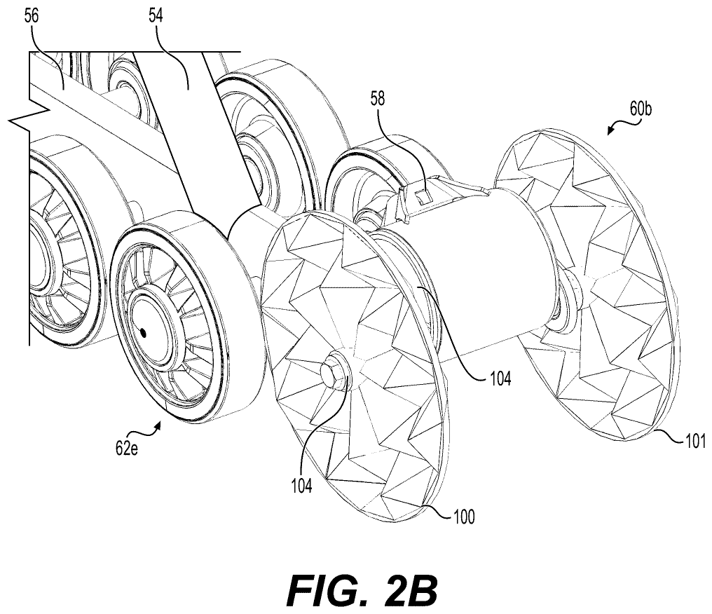

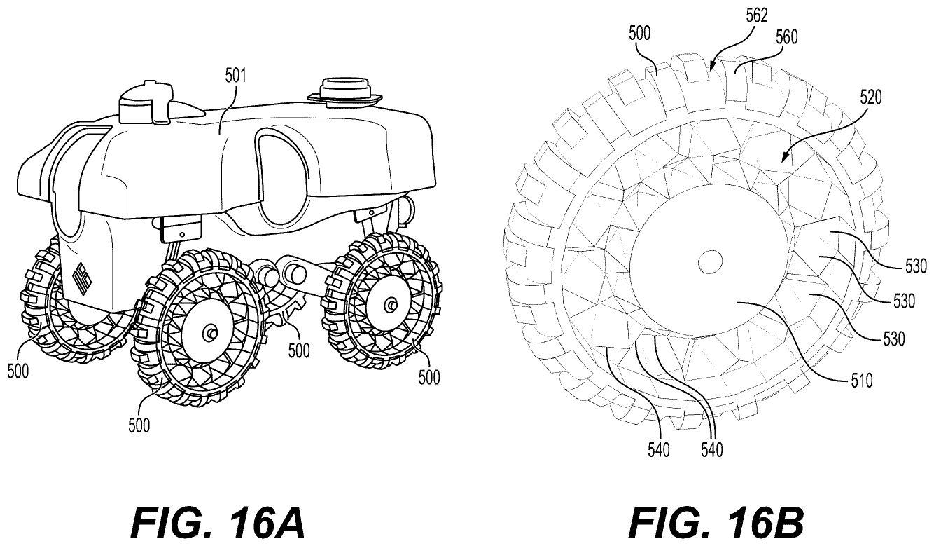

The present technology relates to compliant wheels, which can be part of a track system (FIGS. 1, 2A and 2B), or used as standalone tires (FIGS. 16A and 16B).

With reference to FIGS. 1, 2A and 2B, the present technology will first be described with reference to a track system 30. The track system 30, the forward direction of which is indicated by arrow 31, is operatively connectable to a vehicle (not shown). Specifically, the track system 30 is operatively connectable to a shaft of the vehicle. In some embodiments, the vehicle is a recreational vehicle such as an all-terrain-vehicle, a side-by-side vehicle or utility-terrain vehicle. In other embodiments, the vehicle is a construction vehicle such as a bulldozer, a skid-steer loader, an excavator or a compact track loader. In yet other embodiments, the vehicle is an agricultural vehicle such as a harvester, a combine or a tractor. It is further contemplated that the present technology could be used with industrial, military and exploratory vehicles as well. It is also contemplated that the present technology could be used with trailers or other unpowered vehicles.

The track system 30 includes a sprocket wheel assembly 40 which can be operatively connected to a driving axle (not shown) of the vehicle. It is contemplated that in some embodiments, the sprocket wheel assembly 40 could be connected to a non-driving axle. The driving axle is configured to drive the sprocket wheel assembly 40 such that the sprocket wheel assembly 40 can rotate about a sprocket axis 42. The sprocket axis 42 is generally perpendicular to the forward direction of travel of the track system 30. The sprocket wheel assembly 40 has a plurality of laterally extending engaging members 44 (i.e., teeth) disposed on a circumference thereof. The sprocket wheel assembly 40 defines a plurality of recesses 45, where each one of the recesses 45 is defined between two engaging members 44. The engaging members 44 and the recesses 45 are adapted to engage with lugs 76 provided on an inner surface 72 of an endless track 70. It is contemplated that in other embodiments, the configuration of the sprocket wheel assembly 40 and thus the manner in which the sprocket wheel assembly 40 engages the endless track 70 could differ without departing from the scope of the present technology.

The track system 30 further includes a frame 50. The frame 50 includes a leading frame member 52, a trailing frame member 54 and a lower frame member 56. The leading and trailing frame members 52, 54 are jointly connected, and are configured to be connected around the driving axle of the vehicle. The joint connection is positioned laterally outwardly from the sprocket wheel assembly 40. The leading frame member 52 extends from the driving axle, in the forward and downward directions, and connects to a forward portion of the lower frame member 56. The trailing frame member 54 extends from the driving axle, in the rearward and downward directions, and connects to a rearward portion of the lower frame member 56. The lower frame member 56, which is positioned below the joint connection, extends generally parallel to the forward direction of travel of the track system 30. In the present embodiment, the leading, trailing and lower frame members 52, 54, 56 are integral. It is contemplated that in other embodiments, the leading, trailing and lower frame members 52, 54, 56 could be distinct members connected to one another. It is contemplated that in other embodiments, the configuration of the frame 50 could differ without departing from the scope of the present technology. For instance, it is further contemplated that in some embodiments, the frame 50 could include more or less than three members. In some embodiments, one or more of the leading, trailing and lower frame members 52, 54, 56 could be pivotally connected to one another.

The track system 30 includes a leading idler wheel assembly 60a rotationally connected to a leading end of the lower frame member 56 and a trailing idler wheel assembly 60b connected to the lower frame member 56 via a tensioner 58 that is operable to adjust the tension in the endless track 70 by selectively moving the trailing idler wheel assembly 60b toward or away from the frame 50. It is contemplated that in some embodiments, the tensioner 58 could be connected to the leading idler wheel assembly 60a instead of the trailing idler wheel assembly 60b. In some embodiments, the tensioner could be omitted. Each of the leading and trailing idler wheel assemblies 60a, 60b includes two laterally spaced compliant wheels 100, 101 according to embodiments of the present technology. It is contemplated that in some embodiments the leading and/or trailing idler wheel assembly 60a, 60b could include a single compliant wheel. The compliant wheels 100, 101 will be described in greater detail below.

The track system 30 also includes a plurality of support wheel assemblies. In the illustrated embodiment, the track system 30 includes five support wheel assemblies 62a, 62b, 62c, 62d, 62e, but it is contemplated that the track system 30 could include more or less than five support wheel assemblies. Each of the support wheel assemblies 62a, 62b, 62c, 62d, 62e includes two laterally spaced wheels. In some embodiments, one or more of the support wheel assemblies 62a, 62b, 62c, 62d, 62 could include the compliant wheels 100, 101. It is contemplated that in some embodiments, at least one of the leading and trailing idler wheel assemblies 60a, 60b, and the five support wheel assemblies 62a, 62b, 62c, 62d, 62e could have a single wheel, or three or more wheels. The five support wheel assemblies 62a, 62b, 62c, 62d, 62e which are disposed longitudinally rearwardly from the leading idler wheel assembly 60a, are connected to the lower frame member 56 by, respectively, support structures comprising any conventional required hardware (e.g., axle, bearing, seal, etc.). In some embodiments, the support structures allow the support wheel assemblies 62a, 62b, 62c, 62d, 62e to pivot relative to the lower frame member 56. In some embodiments, two or more of the support wheel assemblies could be connected to one another so as to form a tandem wheel assembly.

The track system 30 comprises the endless track 70, which extends around components of the track system 30, notably the frame 50, the leading and trailing idler wheel assemblies 60a, 60b, the support wheel assemblies 62a, 62b, 62c, 62d, 62e. The endless track 70 has an inner surface 72 and an outer surface 74. The inner surface 72 of endless track 70 comprises lugs 76, which are adapted to engage with the engaging members 44 of the sprocket wheel assembly 40. It is contemplated that in some embodiments, there could be only one set of lugs, or that there could be two or more sets of lugs. The outer surface 74 of the endless track 70 has a tread (not shown) defined thereon. It is contemplated that the tread could vary from one embodiment to another. In some embodiments, the tread could depend on the type of vehicle on which the track system 30 is to be used and/or the type of ground surface on which the vehicle is destined to travel. In the present embodiment, the endless track 70 is an endless polymeric track. It is contemplated that in some embodiments, the endless track 70 could be constructed of a wide variety of materials and structures.

### Compliant Wheel

With reference to FIG. 2B, there is depicted an enlarged representation of the trailing idler wheel assembly 60b, in which the compliant wheels 100, 101 are shown in greater detail. The compliant wheels 100, 101 are interconnected by an axle 104. In some embodiments, the compliant wheels 100, 101 could be connected to distinct axles. In some embodiments, the compliant wheels 100, 101 are identical. In other embodiments, the compliant wheel 101 may be a mirror image of the compliant wheel 100. In some instances, the compliant wheels 100, 101 may be referred to as deformable wheels 100, 101. As the compliant wheels 100, 101 are similar, only the compliant wheel 100 will be described in detail herewith.

The compliant wheel 100 may achieve force and motion transmission through elastic body deformation. Different embodiments of the compliant wheel 100 as contemplated in the context of the present technology will be discussed in greater detail further below. A description of the design such compliant wheels will be provided in greater detail below.

The compliant wheel 100 includes a hub portion 110, a resilient portion 120 and a flexible rim portion 160. In some embodiments, the flexible rim portion 160 may be omitted. As will be described in greater detail below, the resilient portion 120 is deformable.

The hub portion 110 defines an axis 111, which corresponds to a rotation axis of the compliant wheel 100, and a longitudinal plane 112 that extends through a longitudinal center point thereof, such that the longitudinal plane 112 may sometimes be referred to as a longitudinal center plane 112. The hub portion 110 is configured to receive the axle 104 therein, the axle 104 being generally aligned with the axis 111. In some embodiments, the hub portion 110 could be configured to receive a bearing and the axle 104 therein. The hub portion 110 is generally symmetrical about the longitudinal plane 112. It is contemplated that in other embodiments, the hub portion 110 may be asymmetrical about the longitudinal plane 112. The hub portion 110 is rigid. In some embodiments, the hub portion 110 could be made of a metallic material.

The compliant wheel 100 defines an inner side 114 on one side of the longitudinal plane 112 and an outer side 116 on an other side of the longitudinal plane 112. In the present embodiment, the inner and outer sides 112, 114 are defined with respect to the position of the compliant wheel 100 relative to track system 30.

The resilient portion 120, which can sometimes be referred to as a resilient member, extends radially from the hub portion 110. In some embodiments, the resilient portion 120 could be integral with the hub portion 110. In other embodiments, the resilient portion 120 may be a distinct component from the hub portion 110.

It is contemplated that the resilient portion 120 could be made from a wide variety of material. In some embodiments, the resilient portion 120 could be made of a polymeric material such as ultra-high molecular weight polyethylene, high-density polyethylene, polypropylene, and polyurethane. In such embodiments, the resilient portion 120 may be manufactured by an additive manufacturing process such as molding, casting, injection molding and 3D printing. In other embodiments, the resilient portion 120 could be made of a metallic material, such as spring steel. In yet other embodiments, the resilient portion 120 may be made of a composite material such as, for example, a reinforced resin matrix with carbon fiber and/or fiberglass.

### First Embodiment

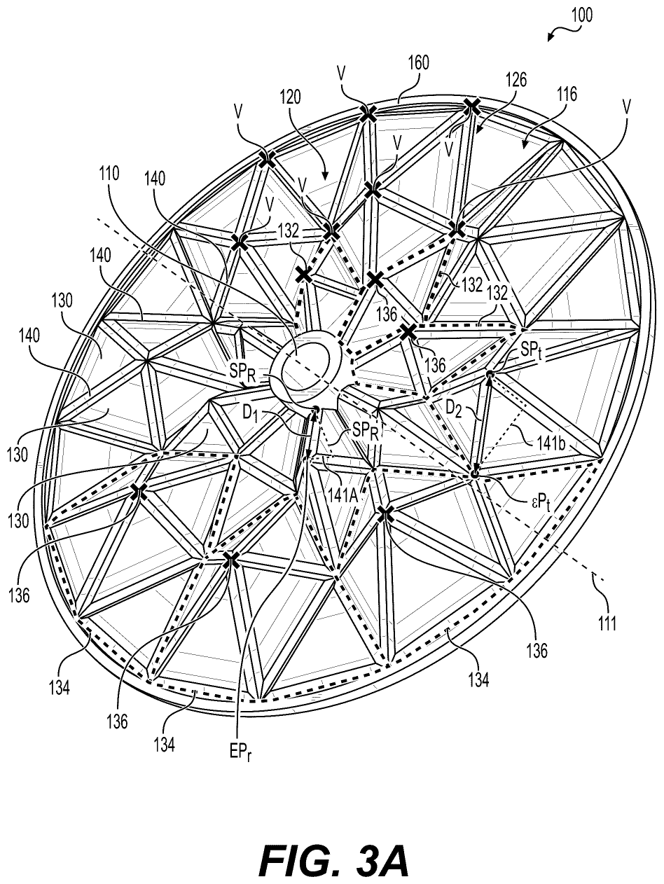

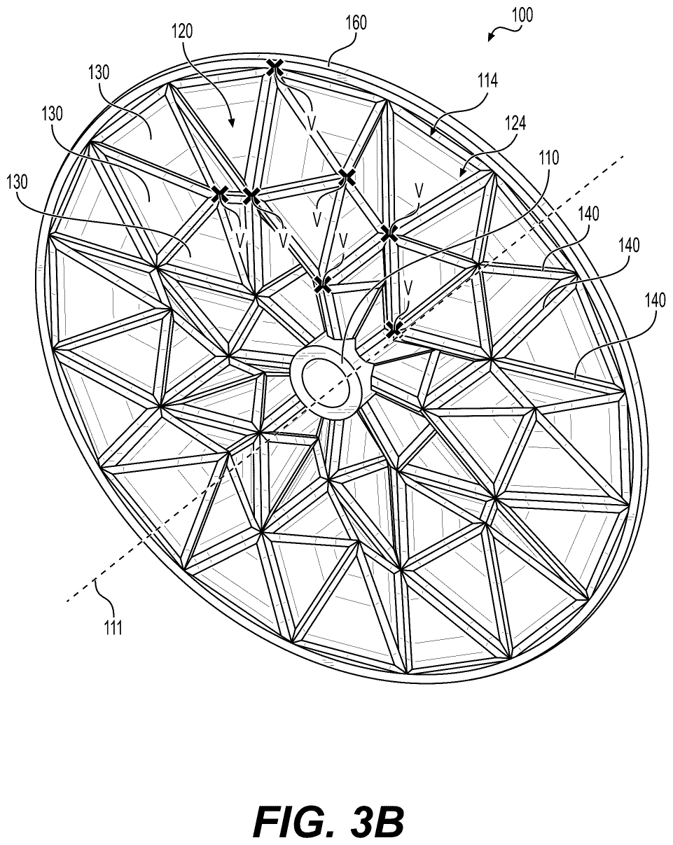

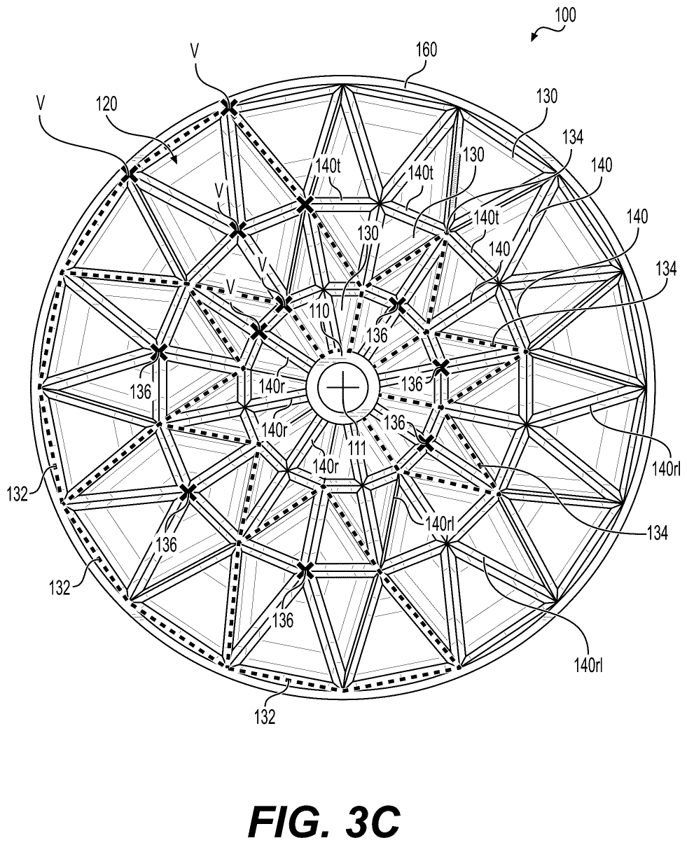

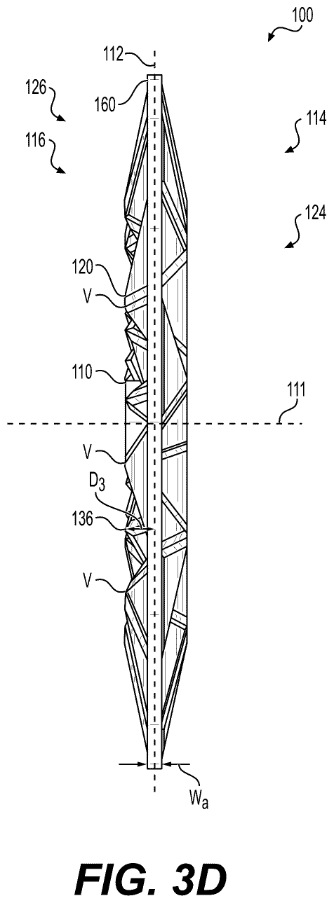

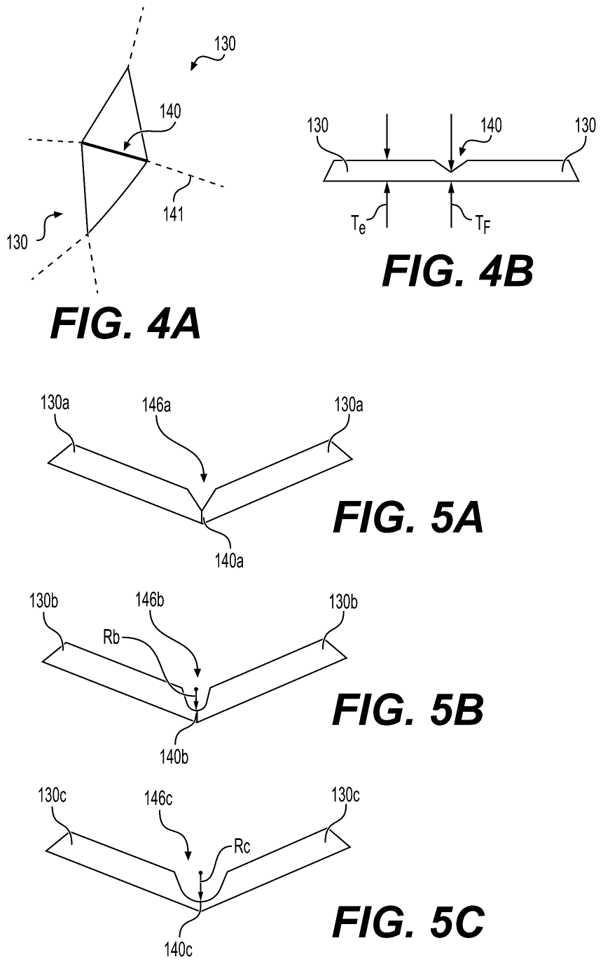

Referring to FIGS. 3A to 3D, the resilient portion 120 according to a first embodiment of the present technology will now be described in greater detail. It will become apparent from the present description that the configuration of the resilient portion 120 can vary considerably from one embodiment to another.

The resilient portion 120 has an inner side 124 that is disposed on one side of the longitudinal plane 112 and that is consistent with the inner side 114 of the compliant wheel 100, and an outer side 126 that is disposed on an other side of the longitudinal plane 112 and that is consistent with the outer side 116 of the compliant wheel 100.

The resilient portion 120 has a plurality of elements 130 and a plurality of fold lines 140, where the elements 130 are connected to one another via a corresponding fold line 140. Adjacent elements 130 are moveable relative to one another. For clarity, only some of the plurality of elements 130 and fold lines 140 are labeled in the accompanying Figures. The resilient portion 120 has a predetermined profile of resiliency that is defined by, inter alia, the plurality of elements 130 and the plurality of fold lines 140. The predetermined profile of resiliency of the resilient portion 120 impacts how much the compliant wheel 100 can deform during operation. As will be described below, the profile of resiliency can be modulated by various factors, rendering the resilient portion 120 easier to deform or harder to deform. The predetermined profile of resiliency is referred to as such, because the compliant wheel 100, and thus the resilient portion 120, can be designed so that it deforms in a certain desired way.

The plurality of elements 130 will first be described in greater detail. The plurality of elements 130 can be disposed so as to form a pattern. In some instances, the elements 130 can be arranged in a clusters. In some embodiments, the clusters could be pyramidal clusters. That is, the elements 130 are generally arranged in a pyramid shape, where as a base of the pyramid can vary in shape (e.g., triangle, diamond, square, etc.). In other embodiments, the clusters can be arranged in a irregular shape.

It can be said that the present embodiment, there is a plurality of inner clusters 132 and a plurality of outer clusters 134. More specifically, there are eight inner clusters 132 and eight outer clusters 134. It is contemplated that the number of clusters could vary from one embodiment of the compliant wheel 100 to another. It is also contemplated that in some embodiments, there could be additional sets of clusters (e.g., intermediate clusters). It will be noted that the inner clusters 132 are rotationally symmetrical about the axis 111, and are pyramidal clusters. The outer clusters 134 are also rotationally symmetrical about the axis 111, but have an irregular cluster shape (pyramid with one extra element). In some embodiments, the inner and outer clusters 132, 134 may be combined to have one supercluster 135 (FIG. 3C).

In this example, the resilient portion 120 is rotationally symmetrical such that if a pattern including one inner cluster 132 and one outer cluster 134 were to be rotated and reproduced eights times at intervals of 45 degrees about the axis 111, the totality of reproduced patterns would form the resilient portion 120.

It should be noted that each one of the inner and outer clusters 132, 134 has an apex 136, which corresponds to a laterally most distant vertex, amongst of plurality of vertices V of the elements 130, from the longitudinal plane 112. In some embodiments, the inner and outer clusters 132, 134 could have more than one apex 136.

It can be said that the inner side 124 of the resilient portion 120 can have a plurality of inner apexes, and that the outer side 126 of the resilient portion 120 can have a plurality of outer apexes. It is contemplated that an apex of one of the inner and outer clusters 132, 134 may be defined by a curved element 130 (e.g., top of a concave element). For example, this may be the case in embodiments where one or more fold lines 140 have of a curved shape with a respective bending radius parameter, as will be described below.

The plurality of elements 130 can vary in shape, size and orientation with respect to one another. For instance, in the illustrated embodiment, the elements 130 all have triangular shapes, but some elements 130 differ in size from other elements 130. Additionally, the elements 130 are oriented differently. As will be described in greater detail below, the elements 130 can vary in shape. For example, some elements 130 could have a diamond shape, a rectangular shape, a pentagonal shape, a hexagonal shape or another shape. It should be noted that the shapes of the elements 130 can modulate the profile of resiliency of the resilient portion 120. For example, the presence of diamond elements may reduce resiliency of the corresponding resilient member.

Additionally, referring to FIGS. 5A, 5B, 5C, each one of the plurality of elements 130 has a thickness Te. In some embodiments, all the elements 130 have the same thickness Te. In other embodiments, the thickness Te can vary from one element 130 to another. Additionally, in some embodiments, the thickness Te of a given element 130 can vary across its length or width. For instance, in some embodiments, the thickness Te of a given element 130 may be at a maximum at its center and/or the given element 130 may be tapered proximate to the edges thereof. It should be noted that the thicknesses Te of the elements 130 can modulate the profile of resiliency of the resilient portion 120.

The plurality of fold lines 140 will now be described in greater detail. Some of the fold lines 140 extend generally radially relative to the hub portion 110 (identified as lines 140r), some of the fold lines 140 extend generally tangentially relative to the hub portion 110 (identified as 140t), and some of the fold lines 140 extend partially radially and partially tangentially (identified as 140rt). It will also be noted that while extending radially and/or tangentially, the fold lines 140 may also extend partially laterally (i.e., at an angle relative to the longitudinal plane 112).

It is contemplated that the profile of resiliency of the resilient portion 120 may be modulated by, inter alia, a number of radial fold lines 140r, and their relative locations in the corresponding resilient portion 120. Likewise, it is contemplated that the profile of resiliency of the resilient portion 120 may be modulated by, inter alia, a number of tangent fold lines 140t, and their relative locations in the corresponding resilient portion 120.

Each fold line 140 defines a bending axis 141 about which the elements 130 that are connected at the corresponding fold line 140 can bend about. In some embodiments, the bending axis 141 may be referred to as a rotation axis and/or a pivot axis. In the present embodiment, each fold line 140 has a thickness Tf. In some embodiments, the thickness Tf can vary from one fold line 140 to another, such that one fold line 140 may be thicker than another fold line 140. In other embodiments, the thickness Tf can vary along a length of a given fold line 140. It should be noted that the thicknesses Tf can modulate the profile of resiliency of the resilient portion 120.

The plurality of fold lines 140 may be manufactured using a subtractive manufacturing process, such as pressing or machining. For example, the resilient portion 120 may be processed so as to reduce its thickness in locations corresponding to the plurality of fold lines 140. In further embodiments, the plurality of fold lines 140 may be manufactured using an additive manufacturing process, such as injection, 3D printing. For example, the resilient portion 120 may be processed so as to increase its thickness in locations corresponding to the plurality of elements 130.

In additional embodiments of the present technology, it should be noted that fold lines 140 may be less resilient than the elements 130. In such embodiments, the elements 130 may contribute more to the resilient deformation of the resilient portion 120 than the fold lines 140, without departing from the scope of the present technology. In these embodiments, it can be said that the fold lines 140 represent a frame section of the resilient portion 120, and the elements 130 represent resilient components interconnecting the frame section.

With reference to FIG. 5A, in which two adjacent elements 130a and the fold line 140a according to one embodiment are depicted, the fold line 140a defines a V-shaped bending area 146a. The thickness Tf in the V-shaped bending area 146a may vary depending on a specific implementation of the present technology. It should be noted that the thickness of material in the V-shaped bending area 146a can modulate the profile of resiliency of the resilient portion 120.

With reference to FIG. 5B, in which two adjacent elements 130b and the fold line 140b according to an alternative embodiment of the technology are depicted, the fold line 140b defines an arcuate bending area 146b. The fold line 140b defines a bending radius Rb.

With reference to FIG. 5C, in which two adjacent elements 130c and the fold line 140c according to an alternative embodiment of the technology are depicted, the fold line 140c defines an arcuate bending area 146c. The fold line 140c defines a bending radius Rc. The arcuate bending area 146c is larger than the arcuate bending area 146b, and the bending radius Rc is greater than the bending radius Rb such that the thickness of the fold line 140c is smaller than the thickness of the fold line 140b. Therefore, in this example, it can be said that the elements 130c can resiliently move more easily with respect to one another than the elements 130b.

In some embodiments, the resilient portion 120 could have one, two or all three of the V-shaped bending area 146a, the arcuate bending area 146b and the arcuate bending area 146c.

It should be noted that the size and shape of the bending areas 146a, 146b, 146c may affect the resilient movement of the elements 130 relative to one another for a given force applied onto a corresponding compliant wheel. That is, the bending areas can modulate the profile of resiliency of the resilient portion 120.

In some embodiments, a given fold line 140 defined in the resilient portion 120 may have a curvature and the radius of this curvature may be referred to as a bending radius parameter for the given folding line.

As will be described in greater detail below, while in the present embodiment the fold lines 140 are depicted as score lines that are thinner than the elements 130, in other embodiments, the fold lines 140 may have the same thickness as the elements 130. In yet other embodiments, the fold lines 140 may be hinges.

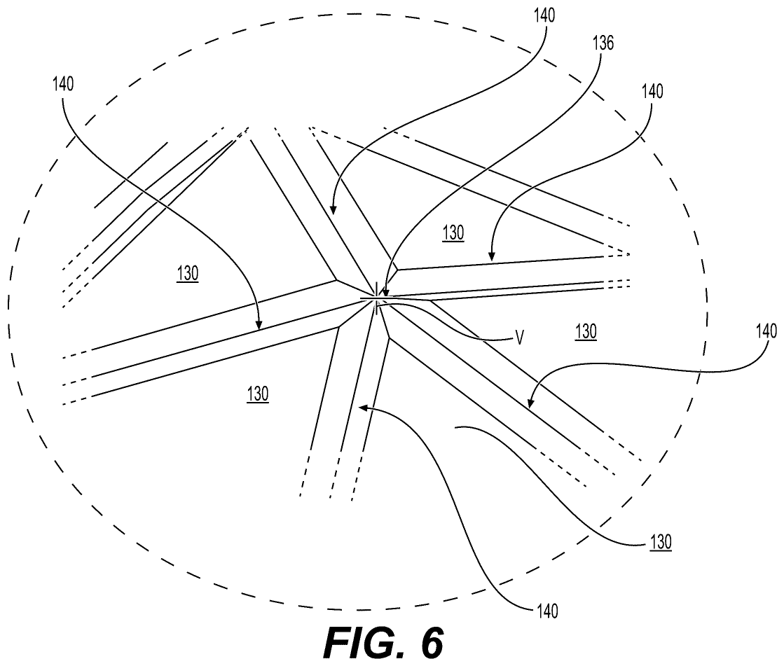

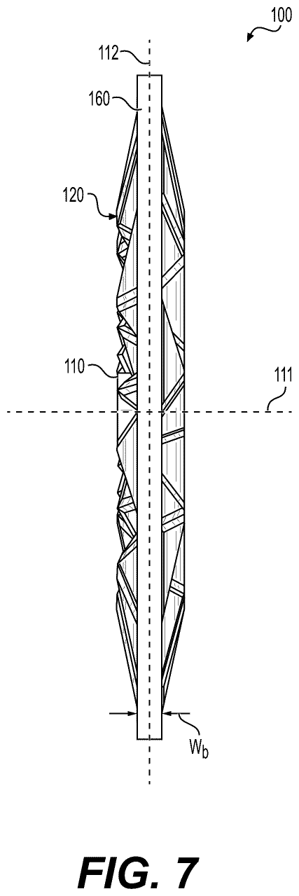

Referring back to FIGS. 3A to 3D and FIG. 7, the flexible rim portion 160 will now be described in greater detail. The flexible rim portion 160 is connected to the resilient portion 120. In some embodiments, the flexible rim portion 160 may be integrally formed with the resilient portion 120. In other embodiments, the flexible rim portion 160 may be overmolded, glued, fastened and/or interlocked with the resilient portion 120, without departing from the scope of the present technology. It is contemplated that the flexible rim portion 160 may be made of a resilient material, such as rubber, foam, and/or plastic. The flexible rim portion 160 may also be made of a metallic material with a resilient coating.

The flexible rim portion 160 extends circumferentially around the resilient portion 120 and forms a peripheral surface of the compliant wheel 100. In the illustrated embodiment, the flexible rim portion 160 defines a circular peripheral surface. However, this may not be the case in each and every embodiment of the present technology. For example, the flexible rim portion 160 may define a polygonal peripheral surface. An outer surface of the flexible rim portion 160 is generally flat (i.e., does not define a tread thereon), and is configured to engage the inner surface 72 of the endless track 70. That said, it is contemplated that in other embodiments, the outer surface of the flexible rim portion 160 may have some type of tread for enhancing traction. More specifically, as will be described below, in embodiments where the compliant wheel 100 is a stand-alone compliant wheel provided on a vehicle, (i.e., without being part of a track system), the flexible rim portion 160 may have a tread on its outer surface.

The flexible rim portion 160 is configured such that when the compliant wheel 100 is subjected to a radial force, the flexible rim portion 160 can deform in the radial direction, along with the flexible portion 120. In some embodiments, the flexible rim portion 160 can modulate the profile of resiliency of the resilient portion 120.

Additionally, during operation, the compliant wheel 100 may undergo a side shift due to the nature of the resilient portion 120. Side shift can be defined as a deformation of the compliant wheel 100 in a direction generally perpendicular to the longitudinal plane 112. The flexible rim portion 160 may assist in reducing the side shift that may occur in the compliant wheel 100 upon the application of a force compared to when the flexible rim portion 160 is omitted from the compliant wheel.

In the embodiment of the compliant wheel 100 depicted in FIG. 3D, the flexible rim portion 160 extends laterally so as to define a width Wa.

In the alternative embodiment of the compliant wheel 100 depicted in FIG. 7, the flexible rim portion 160 extends laterally so as to define a width Wb. The width Wb is greater than the width Wa.

Developers of the present technology have realized that increasing the width of the flexible rim portion 160 can further assist in reducing the side shift that occurs in the compliant wheel 100. Therefore, the presence of the flexible rim portion 160, as well as the width thereof, can modulate the profile of resiliency of the compliant wheel 100.

In some embodiments, the flexible rim portion 160 could have a polygonal outer surface.

### Profile of Resiliency

As mentioned above, the profile of resiliency of the compliant wheel 100 can be modulated by various factors. Some such factors have been described hereabove, such as thicknesses of the elements 130, thicknesses of the fold lines 140, orientation, shape and number of the elements 130 and the fold lines 140. Other factors that can modulate the profile of resiliency of the resilient portion 120 will now be described in greater detail.

As mentioned above, the plurality of elements 130 includes apexes 136. The plurality of elements 130 can also include depressions (may correspond to an apex 136 on the opposing side of the of apex 136) that are connected by at least one of the radial fold lines 140r, the tangent fold line 140t and/or the fold lines 140rt.

A distance D1, shown in FIG. 3A, that extends between a given apex and a given depression connected by a radial fold line 140r may modulate the profile of resiliency of the resilient portion 120. It can be said that the distance D1 may be a lateral offset between a starting point of the radial fold line 140r and an ending point of the radial fold line 140r.

For example, with reference to FIG. 3A, there is depicted a radial fold line 140r having a starting point SPr and an ending point EPr. The radial fold line 140r has a lateral offset 141a which is defined by as lateral distance between the starting point SPr and the ending point EPr. Thus, it is also contemplated that the profile of resiliency of the resilient portion 120 may depend on, inter alia, the lateral offset of radial fold lines 140r.

In additional embodiments, the number of vertices V and/or apexes 136 may be used to modulate the profile of resiliency of the resilient portion 120. Optionally, the number of apexes 136 defined by at least one tangential fold line 140t and/or the number of apexes 136 defined by at least one radial folding line 140r can modulate the profile of resiliency of the resilient portion 120.

A distance D2, shown in FIG. 3A, that extends between a given apex and a given depression connected by a tangent fold line 140t may modulate the profile of resiliency of the resilient portion 120. It can be said that the distance D2 may be a lateral offset between a starting point of a given tangent fold line 140t and an ending point of the tangent fold line 140t. For example, with reference to FIG. 3A, there is depicted a tangent fold line 140t having a starting point EPt and an ending point EPt. The tangent fold line 140t has a lateral offset 141b which is defined by as lateral distance between the starting point SPt and the ending point EPt. Thus, it is also contemplated that the profile of resiliency of the resilient portion 120 may depend on, inter alia, the lateral offset of tangent fold lines 140t.

A distance between one of the apexes 136 (whether it be on the inner side 125 or outer side 126) and the longitudinal plane 112 also modulate the profile of resiliency of the resilient portion. For example, with reference to FIG. 3D, a lateral distance D3 that extends between one of the apexes 136 and the longitudinal center plane 112 is shown. The selection of the lateral distance D3 may modulate the profile of resiliency of the resilient portion 120.

It is also contemplated that a ratio between various the lateral distances between apexes 136 and the longitudinal plane 112 may be used to modulate the profile of resiliency of the resilient portion 120.

As mentioned above, the resiliency of the flexible rim portion 160 may also modulate the profile of resiliency of the resilient portion 120. It should be noted that depending on the type of material used for the flexible rim portion 160, the width thereof and/or the thickness thereof may affect the profile of resiliency of the resilient portion 120.

As mentioned above, variation of shape amongst the plurality of elements may also be used to modulate the profile of resiliency of the resilient portion 120. For example, the profile of resiliency may vary depending on (i) a number of triangular elements 130 in the resilient portion 120, (ii) a number of diamond elements 130 in the resilient portion 120, (iii) a proportion of triangular elements 130 to diamond elements 130, (iv) specific locations of the triangular elements 130 in the resilient portion 120, (v) specific locations of diamond elements 130 in the resilient portion 120, (vi) relative locations of the triangular elements 130 and the diamond elements 130, and the like. Other parameters for changing the pre-determined profile of resiliency across the resilient member are also contemplated.

### Similar Embodiments

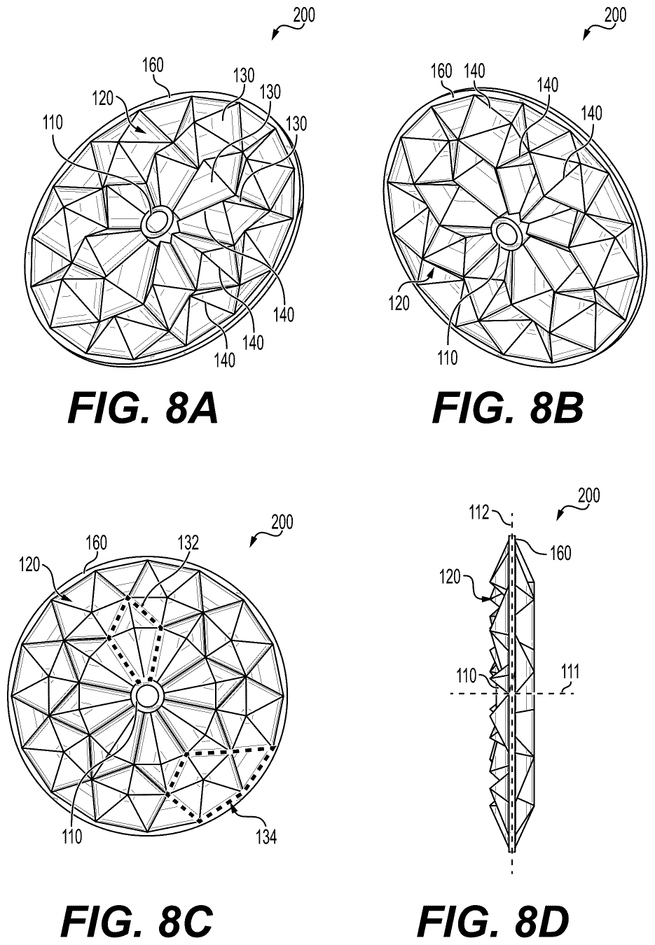

With reference to FIGS. 8A to 8D, 9A to 9D, 10A to 10D, 11A to 11D, 12A to 12D and 13A to 13D, alternative embodiments of the compliant wheel 100 will now be described. It is to be noted that these embodiments are not meant to be limiting, but are rather meant to illustrate different implementations of the present technology. Features of the alternative embodiments that are similar to features of the compliant wheel 100 will be labeled with the same reference numerals, and will not be re-described.

Referring to FIGS. 8A to 8D, a compliant wheel 200 is shown. The compliant wheel 200 notably differs from the compliant wheel 100 in that the elements 130 each have the same uniform thickness. That is, material is not removed in order to manufacture the fold lines 140 and/or material is not removed proximate to the fold lines 140. The pattern defined by the elements 130 and the fold lines 140 is generally similar to the pattern of the compliant wheel 100 (i.e., inner and outer clusters 132, 134 are generally similar).

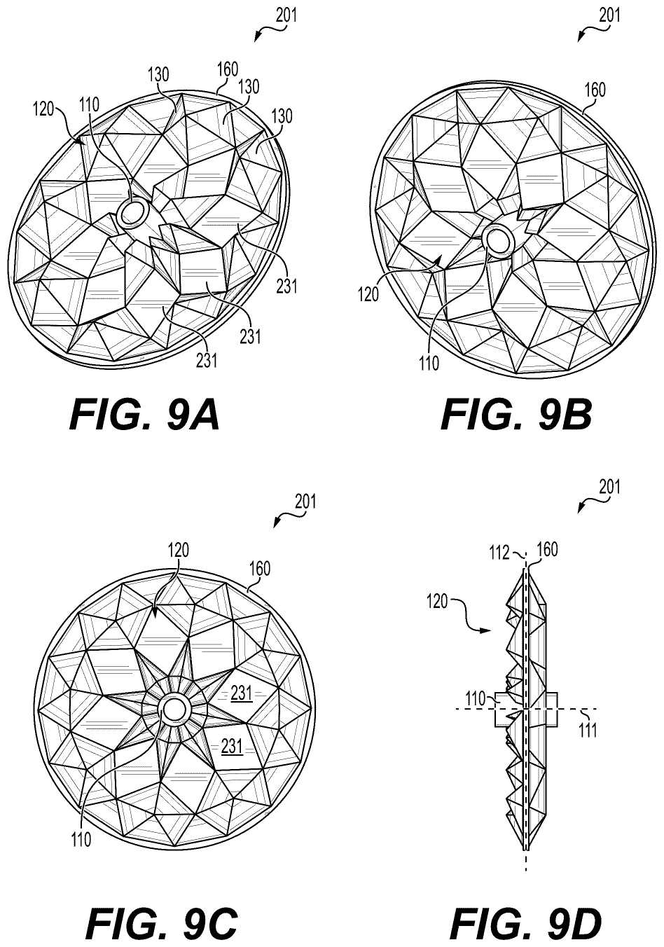

Referring to FIGS. 9A to 9D, a compliant wheel 201 is shown. The compliant wheel 201 notably differs from the compliant wheel 200 in that elements 130 are arranged differently, and have different shapes and sizes. More specifically, the compliant wheel 201 has diamond shaped elements 231 disposed generally between the inner and outer clusters 132, 134. As mentioned above, the diamond shaped elements 231 are configured to modulate the profile of resiliency of the compliant wheel 201 by making it harder for the compliant wheel 201 to deform.

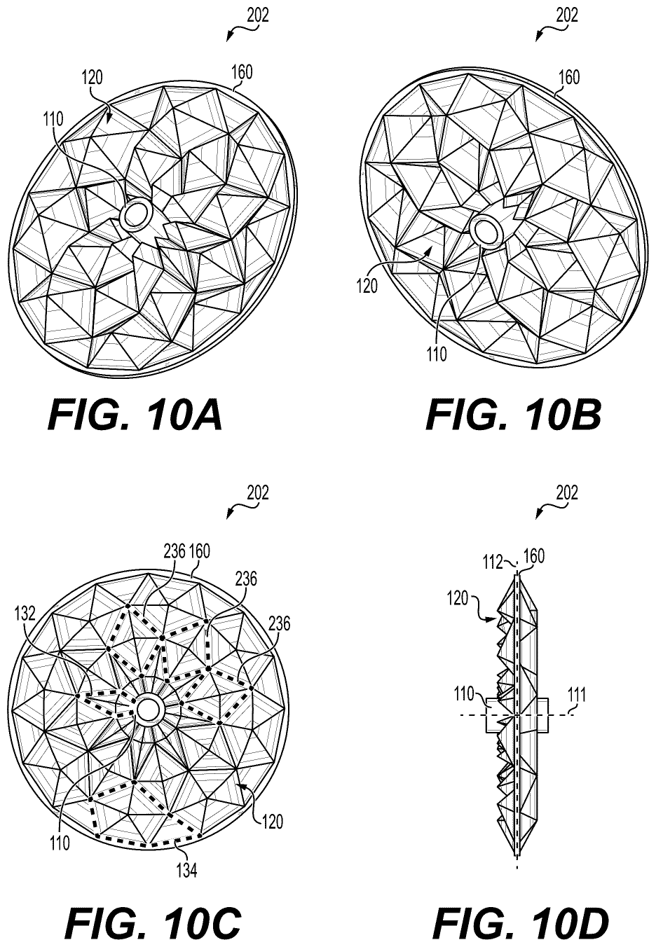

Referring to FIGS. 10A to 10D, a compliant wheel 202 is shown. The compliant wheel 202 notably differs from the compliant wheel 200 in that the resilient portion 120 further has intermediate clusters 236 that is disposed between the inner and outer clusters 132, 134 and that is formed by the elements 130. The intermediate clusters 236 are arranged to be pyramidal clusters. As mentioned above, the different arrangement of the elements 130 can modulate the profile of resiliency of the compliant wheel 202.

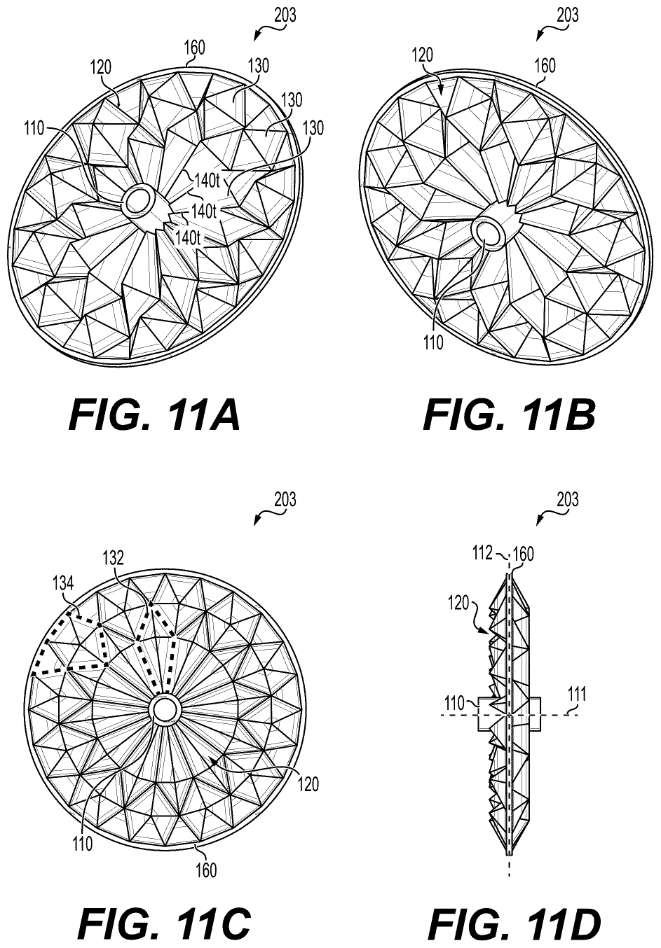

Referring to FIGS. 11A to 11D, a compliant wheel 203 is shown. The compliant wheel 203 notably differs from the compliant wheel 200 in that elements 130 are shaped and arranged differently. In this embodiment, the number of inner and outer clusters 132, 134 have been increased from eight to twelve. Additionally, the size of the elements 130 of the inner clusters 132 has been changed to increase a length of the radial fold lines 140r of the inner clusters 132 that extend in the radial direction. As mentioned above, the change in arrangement of the elements 130 as well as a change of the fold lines 140 can modulate the profile of resiliency of the compliant wheel 203.

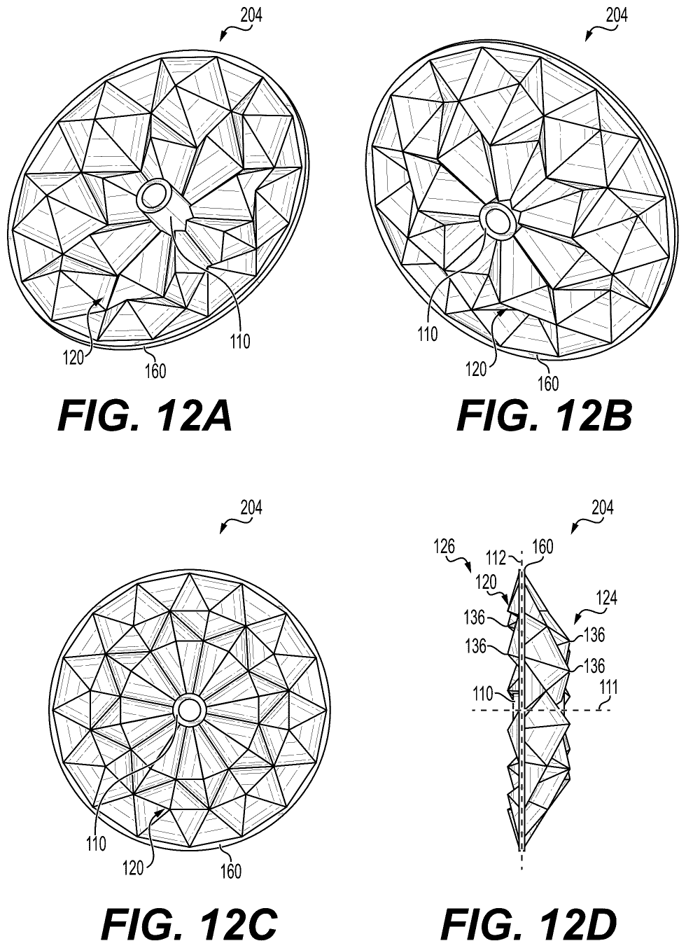

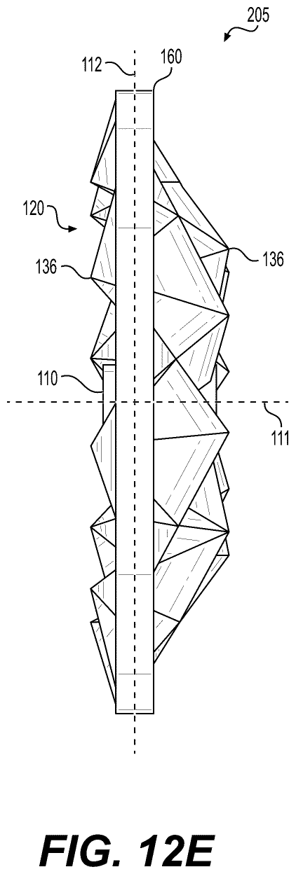

Referring to FIGS. 12A to 12D, a compliant wheel 204 is shown. The compliant wheel 204 notably differs from the compliant wheel 200, in that the apexes 136 on the inner side 124 of the resilient portion 120 are disposed laterally further away from the longitudinal plane 112 than the apexes 136 on the outer side 126 of the resilient portion. As a result, the resilient portion 120 is not symmetrical about the longitudinal plane 112. In some instances, due to the configuration of the compliant wheel 204, the profile of resiliency of the resilient portion 120 may be configured to induce side shift and/or prevent side shift in a given direction.

Referring to FIG. 12E, a compliant wheel 205 is shown. The compliant wheel 205 notably differs from the compliant wheel 204 in that the flexible rim portion 160 of the compliant wheel 205 has a greater width than the flexible rim portion 160 of the compliant wheel 204. As mentioned above, the increase in the width of the flexible rim portion 160 of the compliant wheel 205, may result in a reduction of side shift that occurs therein.

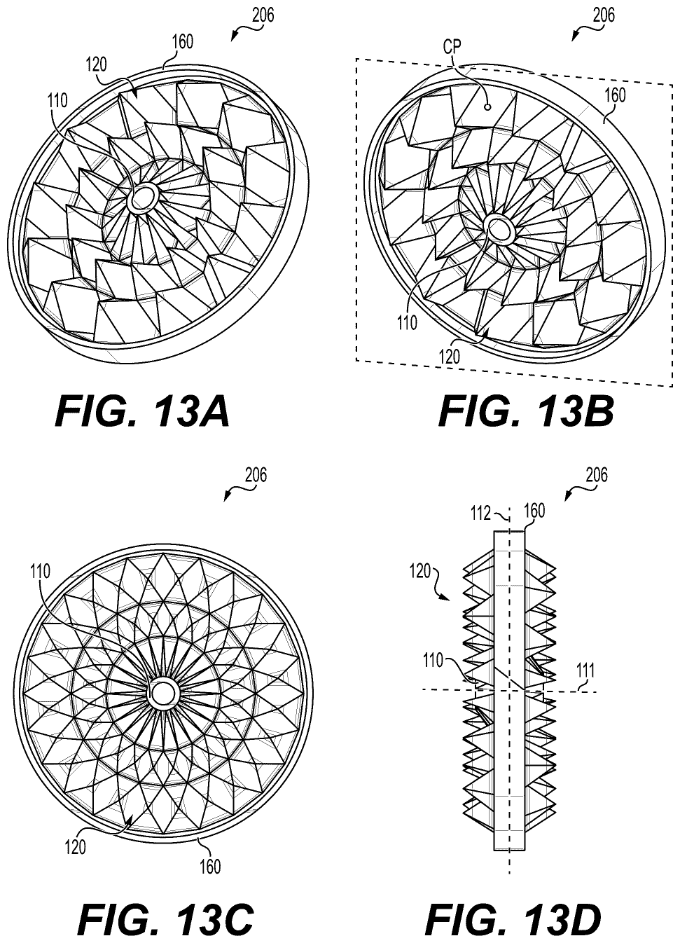

Referring to FIGS. 13A TO 13D, a compliant wheel 206 is shown. The compliant wheel 206 notably differs from the compliant wheel 200 in that elements 130 are shaped and arranged differently, with some of the elements 130 being shaped as diamonds and triangles. In this embodiment, some of the diamond shaped elements 130 define a central point CP that is aligned with the longitudinal plane 112. The compliant wheel 206 is configured to be symmetrical about the longitudinal plane 112, and therefore limit, and in some instances prevent, side shift that may occur therein. The width of the flexible rim portion 160 is further increased in size, when compared to the flexible rim portion 160 of the compliant wheel 200, for further limiting side shift thereof.

Embodiment with Hinge Assembly

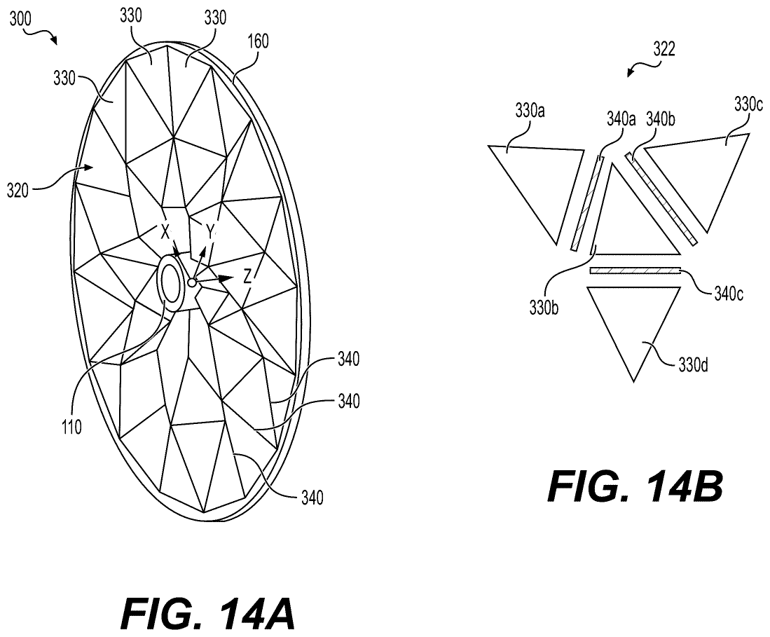

With reference to FIGS. 14A and 14B, an alternative embodiment of the compliant wheel 100, namely compliant wheel 300, will be described in greater detail. Features of the compliant wheel 300 similar to those of the compliant wheel 100 have been labeled with the same reference numerals and will not be described in detail herewith again. In this embodiment, the compliant wheel 300 has the hub portion 110, a resilient portion 320, and the flexible rim portion 160.

In this embodiment, the resilient portion 320 is formed from a plurality of separate elements 330 connected via hinge structures 340. In this embodiment, the hinge structures 340 are located at the fold lines 140 between the plurality of elements 330. In some embodiments, the hinge structures 340 and the fold line 140 can be considered to be the same. Thus, in this embodiment, the resilient portion 320 can be said to be an assembly of components, as opposed to being formed from an integral component. For example, a kit of components may be used to form the resilient portion 320, where the kit of components includes a set of individual components 322. In this example, the set of individual components 322 includes elements 330a, 330b, 330c, 330d, and hinge structures 340a, 340b, 340c.

It can also be said that a first element and a second element are connected in a hinge configuration at a respective one of the fold lines. In these embodiments, the hinge configuration includes a resilient hinge joining the first and second elements. Other hinge configurations are contemplated.

In further embodiments of the present technology, a given resilient portion may be a “hybrid” resilient portion having some elements that are integrally formed and other elements that are separate components connected by hinge structures. For example, a given hybrid resilient portion may include (i) an integral portion including a first subset of integrally formed elements and (ii) an assembly portion including a second subset of separate elements connected via hinge structures. In some embodiments, the integral portion of a hybrid resilient member may extend radially from the hub portion, and the assembly portion may extend radially away from the integral portion. In other embodiments, the assembly portion of a hybrid resilient member may extend radially from the hub portion, and the integral portion may extend radially away from the assembly portion.

The hinge structures 340 can assist in modulating the profile of resiliency of the resilient portion 320.

Embodiment without Rim Portion

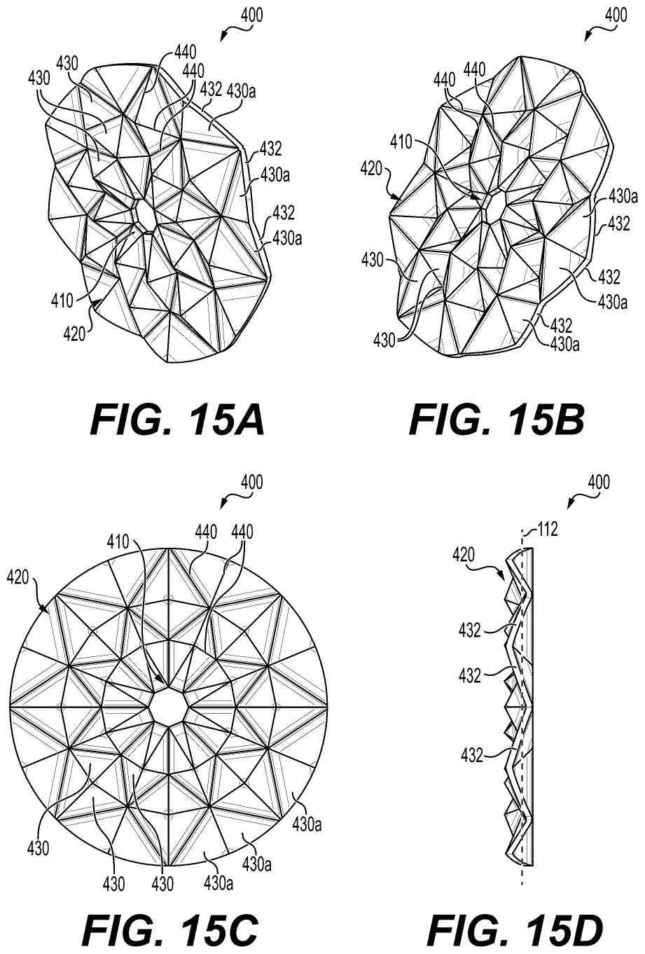

With reference to FIGS. 15A to 15D, an alternative embodiment of the compliant wheel 100, namely compliant wheel 400, will now be described in greater detail. The compliant wheel 400 has a hub portion 410 and a resilient portion 420. In the illustrated embodiment, the compliant wheel 100 does not include a flexible rim portion 160. The hub portion 410 defines an aperture for receiving a shaft there through. The resilient portion 420 has a plurality of elements 430 and a plurality of fold lines 440.

Some of the plurality of elements 430 are peripheral elements 430a. The peripheral elements 430a are disposed on a radially outer point of the resilient portion 420. Adjacent peripheral elements 430a extend at an angle from each other (and thus at an angle from the longitudinal plane 112), which results in a zig-zag configuration. More specifically, the peripheral elements 430a each have a peripheral edge 432 that extend at an angle relative to one another and relative to the longitudinal plane 112. The peripheral edges 432 can be said to be disposed in a chevron-like configuration. It can be said that the compliant wheel 400 has a polygonal peripheral surface. The zig-zag configuration can increase a lateral footprint of the compliant wheel 400.

It is contemplated that the zig-zag configuration may allow a better distribution of forces applied on the endless track 70, which can reduce wear of the endless track 70. In other embodiments, the polygonal peripheral surface may increase friction between the compliant wheel 400 and the endless track 70, thereby reducing the risk of the compliant wheel 400 “slipping” on the endless track 70.

Embodiment with Tire

With reference to FIGS. 16A and 16B, an alternative embodiment of the compliant wheel 100, namely compliant wheel 500, will be described. In this embodiment, there are four compliant wheels 500 that are connected to a robot 501. Thus, the compliant wheels 500 are not used with endless tracks.

In this embodiment, the compliant wheel 500 includes a rim portion 510, a resilient portion 520, which has a plurality of elements 530 and a plurality of fold lines 540, and a rim portion 560 that are similar to, respectively, the rim portion 110, the resilient portion 120 and the flexible rim portion 160.

The compliant wheel 500 is notably different from the compliant wheel 100 in that the hub portion 510 is larger than the hub portion 110. Additionally, the rim portion 560 defines a tread 562 on an outer surface thereon, for enhancing friction with the ground.

### Operation of the Compliant Wheel

With reference to FIGS. 18A to 18C, there is depicted a schematic illustration depicting a compliant wheel according to an embodiment of the present technology that conserves its perimeter when a load is applied thereto. While the following will refer to the compliant wheel 100, it is understood that this may be applicable to any of the other compliant wheels described hereabove.

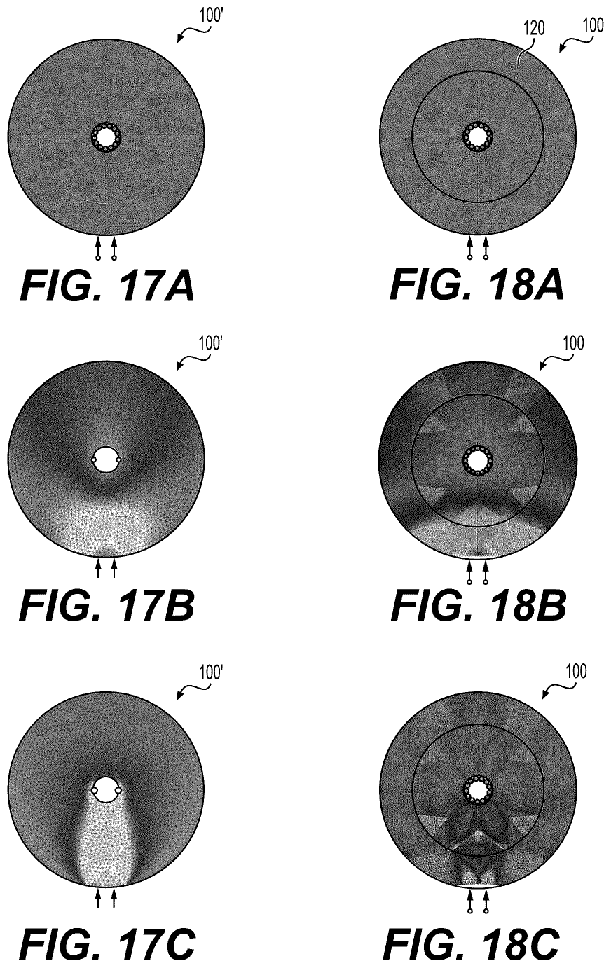

In FIG. 17A, a conventional wheel 100′ as known in the art is shown, in an unloaded state. In FIG. 18A, the compliant wheel 100 is also shown in an unloaded state.

In FIG. 17B, the conventional wheel 100′ is shown in a first loaded state, due to the application of a first force thereon. In FIG. 18B, the compliant wheel 100 is also shown in a first loaded state, due to the application of the same first force thereon. As depicted in the FIGS. 17B, 18B, the first force is spread out over a larger area in the compliant wheel 100 than in the conventional wheel 100′, such that the first force is more localized in the conventional wheel 100′. Indeed, the compliant wheel 100 has, due to the elements 130 and the fold lines 140, partially deformed, thereby enabling spreading of the first force across the resilient portion 120. Spreading out the forces over a larger area results in decreasing pressure applied on the endless track 70, which can enhance life thereof. Life of the compliant wheel 100 can also be extended.

In FIG. 17C, the conventional wheel 100′ is shown in a second loaded state due to the application of a second force thereon, where the second force is greater than the first force. In FIG. 18C, the compliant wheel 100 is also shown in a second loaded state due to the application of the same second force thereon. As mentioned above, the second force is more localized in the conventional wheel 100′, whereas the second force is more spread out across the resilient portion 120 of the compliant wheel 100.

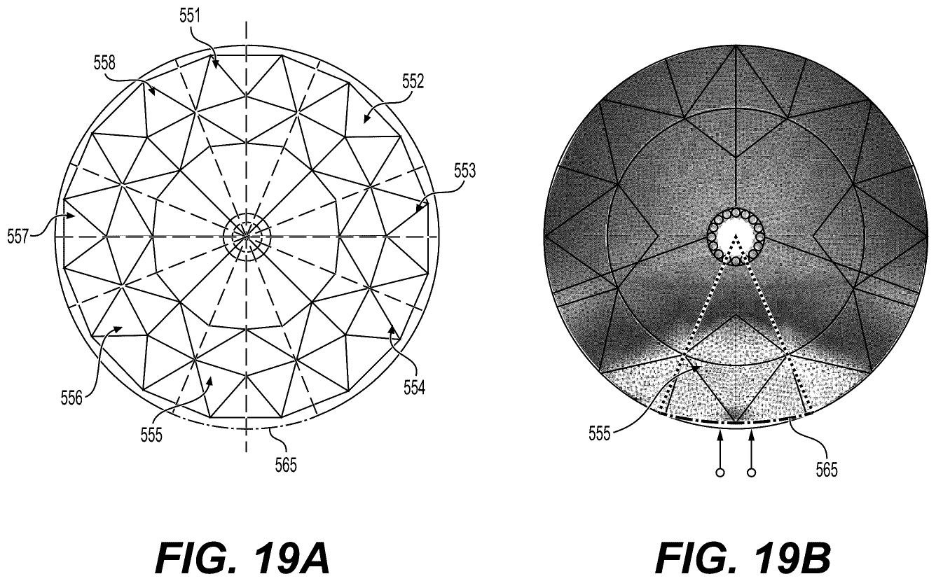

Referring to FIGS. 19A and 19B, when the compliant wheel 100 is in an unloaded state, (e.g., at rest), the compliant wheel 100 has a first perimeter. In response to a force being applied to the compliant wheel 100, the compliant wheel 100 deforms to loaded state due to at least some of the plurality of elements 130 moving about their respective bend axes 141 axes (and potentially about at least some of other bend axes). As a result, the compliant wheel 100 has a second perimeter that is substantially equal to the first perimeter. In some embodiments, a ratio of deformation of the second perimeter over the first perimeter may be between 0.60 and 1.0. In other embodiments, the ratio of deformation of the second perimeter over the first perimeter may be between 0.60 and 1.2. In further embodiments, the ratio of deformation of the second perimeter over the first perimeter may be equal to 1.5.

In some embodiments, it can be said that the resilient portion 120 can be divided in a plurality of equal sections, each section of the plurality of portions comprises a peripheral element. For example, with reference to FIG. 19A, there is depicted a profile view of the compliant wheel 100 in the unloaded state, with a plurality of sections 551, 552, 553, 554, 555, 556, 557, 558. Each one of the sections 551, 552, 553, 554, 555, 556, 557, 558 defines a peripheral segment of the profile perimeter. For example, the section 555 defines a peripheral segment 565. In the unloaded state, the length of all the peripheral segment is the same.

During operation, when the compliant wheel 100 encounters an obstacle, the compliant wheel 100 is configured to resiliently and temporarily deform as shown in FIG. 19B. In this loaded state, the compliant wheel 100 has a D-like profile shape (i.e., has a generally flat segment), as opposed to a circular profile shape when the compliant wheel 100 is in the unloaded state. It should be noted however that when the section 555 of the compliant wheel 100 deforms due to overcoming of the obstacle (giving it the D-like profile shape), at least one of the other sections of the compliant wheel 100 may deform itself resiliently and temporarily for compensating for the change of shape of the section 555 of. It can be said that the at least one section of a compliant wheel may deform itself resiliently and temporarily in an “unfolding” manner to increase a length of a corresponding profile segment.

In this example, the length of the peripheral segment 565 in the unloaded state is shorter than the length of the peripheral segment 565 in the loaded state. As a result, although the profile shape of the compliant wheel 100 changes from a circular profile shape to a D-like profile shape, the profile perimeter of the compliant wheel 100 remains substantially the same. This can assist in limiting chances of the endless track 70 from de-tracking.

As a result, in the loaded state, it can be said that the length of at least some peripheral segments may increase, decrease, and/or remain substantially the same, resulting in the profile perimeter remaining generally the same.

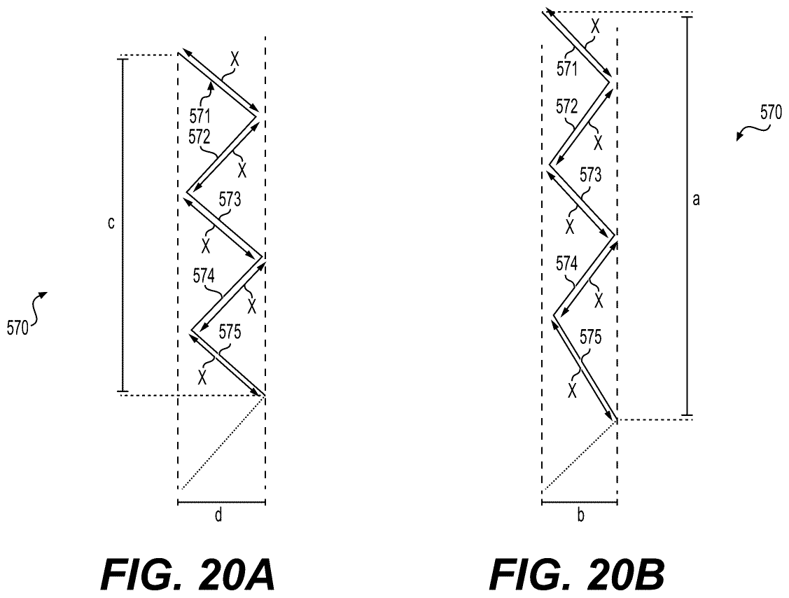

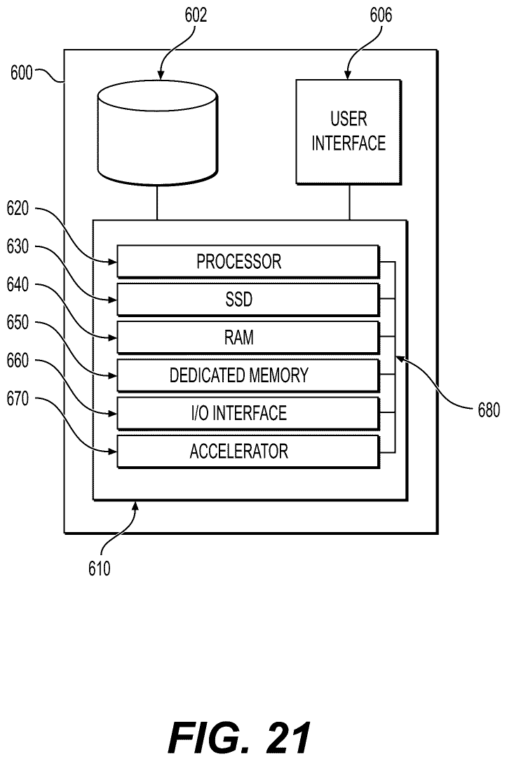

It should be noted that during operation, a footprint of a compliant wheel may vary. Using the compliant wheel 400 as example, depending on whether the compliant wheel 400 is in a loaded or unloaded state. In FIG. 20A, a footprint 570 is shown while the compliant wheel 400 is at rest (or during steady operation). In FIG. 20B, the footprint 570 is shown while the compliant wheel 400 is in a loaded state (e.g., when overcoming an obstacle).

In this example, the footprint 570 is composed of sequential peripheral edges of the compliant wheel 400, including edges 571, 572, 573, 574, 575. Each of the edges 571, 572, 573, 574, 575 has a length “x”. In the unloaded state, the footprint 570 corresponds to a distance “a” covered by the compliant wheel 400. In the unloaded state, the footprint 570 has a width “b”. In response to being deformed to the loaded state, the compliant wheel 400 deforms resiliently and temporarily such that the footprint 570 covers a distance “c” with the same five sequential peripheral edges, and has a width “d”.

It should be noted that the distance “c” covered by the five sequential peripheral edges 571, 572, 573, 574, 575 of the compliant wheel 400 in the loaded state is smaller than the distance “a” covered by the same five sequential peripheral edges 571, 572, 573, 574, 575 of the compliant wheel 400 in the unloaded state. Also, it should be noted that the width “b” of the compliant wheel 400 is smaller in the unloaded state than the width “d” of the compliant wheel 400 in the loaded state.

### Computer System

It is contemplated that the compliant wheels 100, 200, 201, 202, 203, 204, 205, 206, 400, 500 may be designed by a human operator using a computer system 600 of FIG. 21 which will now be described. While reference is made to the compliant wheel 100 in the track system 30, it is understood that the computer system 600 can work similarly for any of the other compliant wheels.

The functions of the various elements shown in the figures, including any functional block labeled as a “processor” or “processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

Referring to 21, there is shown a schematic diagram of the system 600, the system 600 being suitable for implementing non-limiting embodiments of the present technology. It is to be expressly understood that the system 600 as depicted is merely an illustrative implementation of the present technology. Thus, the description thereof that follows is intended to be only a description of illustrative examples of the present technology. This description is not intended to define the scope or set forth the bounds of the present technology. In some cases, what is believed to be helpful examples of modifications to the system 600 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 600 may provide in certain instances simple implementations of the present technology, and that where such is the case they have been presented in this manner as an aid to understanding. As persons skilled in the art would understand, various implementations of the present technology may be of a greater complexity.

Generally speaking, the system 600 is configured to acquire data captured by one or more sensor devices of the track system 30 to which the system 600 is communicatively connected, process the acquired data, determine one or more operational parameters of one or more components of the track system 30 (and/or a current state of the track system 30), and trigger one or more actions based on the one or more operational parameters (and/or the current state).

The computer system 600 comprises a computing unit 610. In some embodiments, the computing unit 610 may be implemented by any of a conventional personal computer, a controller, and/or an electronic device (e.g., a server, a controller unit, a control device, a monitoring device etc.) and/or any combination thereof appropriate to the relevant task at hand. In some embodiments, the computing unit 610 comprises various hardware components including one or more single or multi-core processors collectively represented by a processor 620, a solid-state drive 630, a RAM 640, a dedicated memory 650 and an input/output interface 660. The computing unit 610 may be a generic computer system.

In some other embodiments, the computing unit 610 may be an “off the shelf” generic computer system. In some embodiments, the computing unit 610 may also be distributed amongst multiple systems. The computing unit 610 may also be specifically dedicated to the implementation of the present technology. As a person in the art of the present technology may appreciate, multiple variations as to how the computing unit 610 is implemented may be envisioned without departing from the scope of the present technology.

Communication between the various components of the computing unit 610 may be enabled by one or more internal and/or external buses 680 (e.g. a PCI bus, universal serial bus, IEEE 1394 “Firewire” bus, SCSI bus, Serial-ATA bus, ARINC bus, etc.), to which the various hardware components are electronically coupled.

The input/output interface 660 may provide networking capabilities such as wired or wireless access. As an example, the input/output interface 660 may comprise a networking interface such as, but not limited to, one or more network ports, one or more network sockets, one or more network interface controllers and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 630 stores program instructions suitable for being loaded into the RAM 640 and executed by the processor 620. Although illustrated as a solid-state drive 630, any type of memory may be used in place of the solid-state drive 630, such as a hard disk, optical disk, and/or removable storage media.

The processor 620 may be a general-purpose processor, such as a central processing unit (CPU) or a processor dedicated to a specific purpose, such as a digital signal processor (DSP). In some embodiments, the processor 620 may also rely on an accelerator 670 dedicated to certain given tasks. In some embodiments, the processor 620 or the accelerator 670 may be implemented as one or more field programmable gate arrays (FPGAs). Moreover, explicit use of the term “processor”, should not be construed to refer exclusively to hardware capable of executing software, and may implicitly include, without limitation, application specific integrated circuit (ASIC), read-only memory (ROM) for storing software, RAM, and non-volatile storage. Other hardware, conventional and/or custom, may also be included.

Further, the computer system 600 includes a Human-Machine Interface (HMI) 606. The HMI 606 may include a screen or a display capable of rendering an interface including one or more notifications triggered by the computer system 600. In this embodiment, the display of the HMI 606 includes and/or be housed with a touchscreen to permit users to input data via some combination of virtual keyboards, icons, menus, or other Graphical User Interfaces (GUIs). The HMI 606 may thus be referred to as a user interface 606. In some embodiments, the display of the user interface 506 may be implemented using a Liquid Crystal Display (LCD) display or a Light Emitting Diode (LED) display, such as an Organic LED (OLED) display. At least some portions of the user interface 606 may be integrated into a dashboard of the vehicle operable by the user. The device may be, for example and without being limitative, a handheld computer, a personal digital assistant, a cellular phone, a network device, a smartphone, a navigation device, an e-mail device, a game console, or a combination of two or more of these data processing devices or other data processing devices. For example, the user may communicate with the computing unit 610 (i.e. send instructions thereto and receive information therefrom) by using the user interface 606 wirelessly connected to the computing unit 610. The computing unit 610 may be communicate with the user interface 606 via a network (not shown) such as a Local Area Network (LAN) and/or a wireless connection such as a Wireless Local Area Network (WLAN).

The computer system 600 may comprise a memory 602 communicably connected to the computing unit 610 for storing data received, processed, and/or generated by the computer system 600. The memory 602 may be embedded in the system 600 as in the illustrated embodiment of FIG. 21 or located in an external physical location. The computing unit 610 may be configured to access a content of the memory 602 via a network (not shown) such as a Local Area Network (LAN) and/or a wireless connection such as a Wireless Local Area Network (WLAN).

The system 600 may also include a power system (not depicted) for powering the various components. The power system may include a power management system, one or more power sources (e.g., battery, alternating current (AC)), a recharging system, a power failure detection circuit, a power converter or inverter and any other components associated with the generation, management and distribution of power in mobile or non-mobile devices.

It should be noted that the computing unit 610 may be implemented as a conventional computer server. In an example of an embodiment of the present technology, the computing unit 610 may be implemented as a Dell™ PowerEdge™ Server running the Microsoft™ Windows Server™ operating system. Needless to say, the computing unit 610 may be implemented in any other suitable hardware, software, and/or firmware, or a combination thereof. In the depicted non-limiting embodiments of the present technology in FIG. 21, the computing unit 610 is a single computer device. In alternative non-limiting embodiments of the present technology, the functionality of the computing unit 610 may be distributed and may be implemented via multiple computer devices.

Those skilled in the art will appreciate that processor 620 is generally representative of a processing capability that may be provided by, for example, a Central Processing Unit (CPU). In some embodiments, in place of or in addition to one or more conventional CPUs, one or more specialized processing cores may be provided. For example, one or more Graphic Processing Units (GPUs), Tensor Processing Units (TPUs), accelerated processors (or processing accelerators) and/or any other processing unit suitable for training and executing an MLA may be provided in addition to or in place of one or more CPUs. In this embodiment, the processing unit 620 of the computing unit 610 is a Graphical Processing Unit (GPU) and the dedicated memory 640 is a Video Random access Memory (VRAM) of the processing unit 610. In alternative embodiments, the dedicated memory 640 may be a Random Access Memory (RAM), a Video Random Access Memory (VRAM), a Window Random Access Memory (WRAM), a Multibank Dynamic Random Access Memory (MDRAM), a Double Data Rate (DDR) memory, a Graphics Double Data Rate (GDDR) memory, a High Bandwidth Memory (HBM), a Fast-Cycle Random-Access Memory (FCRAM) or any other suitable type of computer memory.

### Design of Compliant Wheel

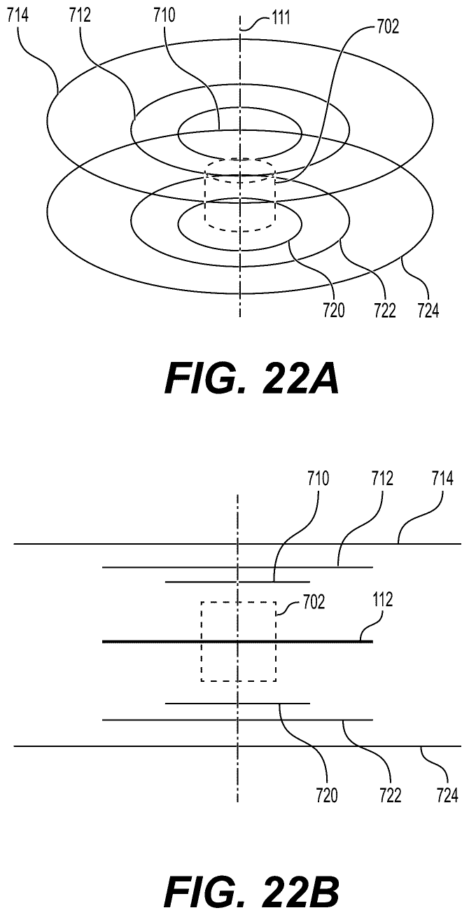

With reference to FIGS. 22A and 22B, there is depicted a schematic representation of geometrical structures generated by the computer system 600 during the design process of a compliant wheel according to an embodiment of the present technology. Reference will be made herewith to features of the compliant wheel 100 for aiding understanding.

During the design process, the computer system 600 may generate a structure representing the hub portion 110 passing through the longitudinal plane 112. The structure representing the hub portion 110 may be in a form of a hollow cylinder 702. The computer system 600 may also generate a plurality of structures representing “orbits”. In this embodiment, there are orbits 710, 712, 714, 720, 722, 724. The orbits 710, 712, 714, 720, 722, 724 are coaxially aligned with the hollow cylinder 702 (and thus with the hub portion 110), and are laterally spaced from the longitudinal plane 112. The orbits 710, 712, 714 are disposed on one side of the longitudinal plane 112 (e.g., inner side) and the orbits 720, 722, 724 are disposed on an other side of longitudinal plane 112 (e.g., outer side). The computer system 600 may generate circular orbits with different diameters and different distances from the longitudinal plane 112. For example, a diameter and/or a location of one of the orbits 710, 712, 714, 720, 722, 724 relative to the longitudinal plane 112 may be inputted by the human operator during the design process. In some embodiments, it is contemplated that the computer system 600 may be configured to generate the diameter and/or the location of one or more of the orbits 710, 712, 714, 720, 722, 724 without human intervention and based on a pre-determined diameter value for given orbits and a pre-determined distances between the given orbits and the longitudinal plane 112.

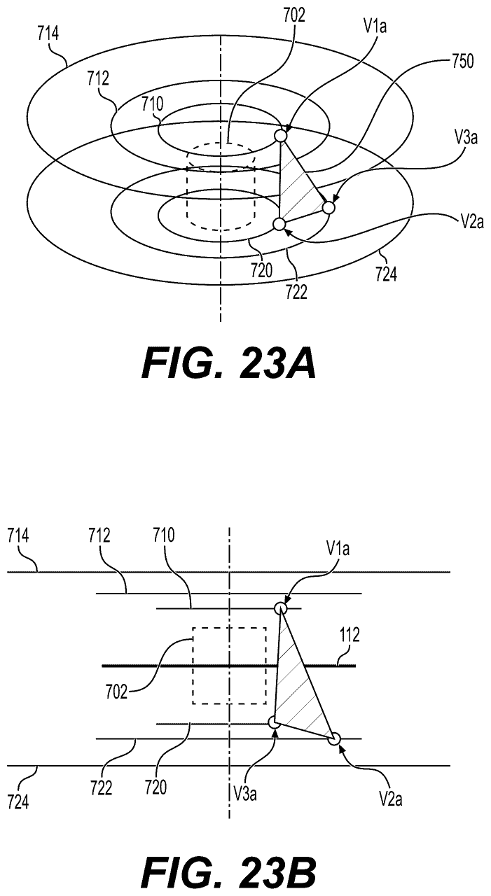

With reference to FIGS. 23A and 23B, there is depicted a schematic representation of geometrical structures generated by the computer system 600 during the design process of a given compliant wheel. In addition to the circular orbits 710, 712, 714, 720, 722, 724 and the hollow cylinder 702 depicted in FIGS. 22A and 22B, the computer system 600 may generate three vertices V1a, V2a, V3a. In some embodiments, the computer system 600 may generate more than three vertices for defining elements that have shapes different from triangles. In some instances, the computer system 600 may receive an input from the human operator indicative of selected locations of the vertices V1a, V2a, V3a. During the design process, the human operator may select one or more locations along one or more of the circular orbits 710, 712, 714, 720, 722, 724 for positioning the corresponding vertices. In other embodiments, it is contemplated that the computer system 600 may be configured to generate vertices without human intervention based on pre-determined parameters such as for example, a number of vertices per orbit, a spacing between vertices on a same orbit, a number of total vertices, and the like.

In the illustrated embodiment, the vertex V1a is positioned along the orbit 710, the vertex V2a is positioned along the orbit 720, the vertex V3a is positioned along the orbit 722. The position of vertices V1a, V2a, V3a may be used by the computer system 600 for generating a triangular element 750, which can be representative of one of the plurality of elements 130. It is contemplated that more than one vertex of a given element may be positioned on a same orbit. For example, the triangular element 750 may have one vertex on the orbit 710, and two vertices of on the orbit 722.

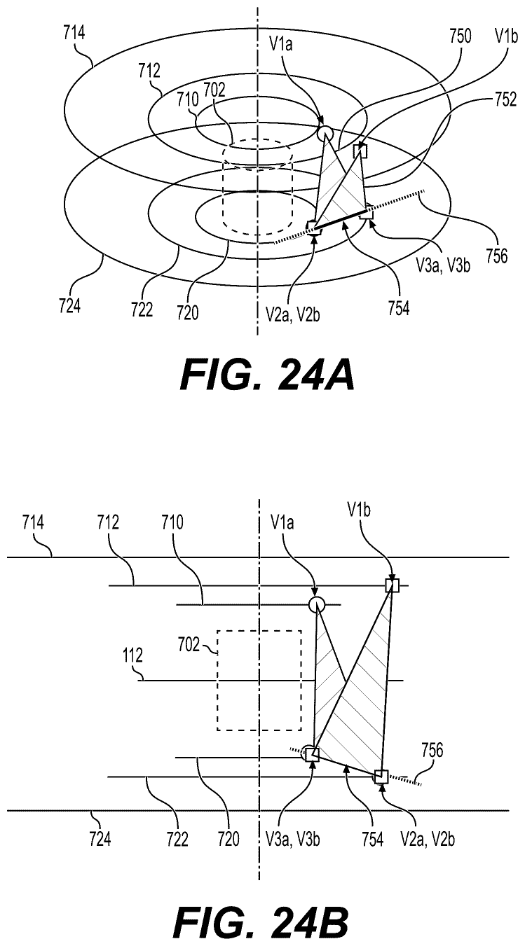

With reference to FIGS. 24A and 24B, there is depicted a schematic representation of geometrical structures generated by the computer system 600 during the design process of a given compliant wheel. In addition to the orbits 710, 712, 714, 720, 722, 724, the hollow cylinder 702, and the element 750 depicted in FIGS. 23A and 23B, the computer system 600 may generate three other vertices V1b, V2b, and V3b. For example, the computer system 600 may receive an input from the human operator indicative of selected locations of the vertices along the plurality of orbits.

In this embodiment, the vertex V1b is positioned along the orbit 712, the vertex V2b is positioned along the orbit 720, and the vertex V3b is positioned along the orbit 724. The position of vertices V1b, V2b, and V3b may be used by the computer system 600 for generating an element 752 which can correspond to one of the elements 130. It should be noted that the elements 750, 752 share a common edge 754 that defines a bend axis 756. Similar to the elements 130 about the bend axis 141, the elements 750, 752 are configured move about the bend axis 756.

Thus, in some embodiments of the present technology, a first element and a second element may share a common edge corresponding to a respective fold line.

It is contemplated that a first surface of the first element may be generally flat and may extend along a first plane, a second surface may be generally flat and may extend along a second plane, and the first plane may be at an angle relative to the second plane. For example, element 750 has a generally flat surface, and extends generally at an angle from the longitudinal plane 112. Similarly, the element 752 has a generally flat surface and extends generally at an angle from the longitudinal plane 112. Additionally, the elements 752, 754 are at an angle relative to one another. It is contemplated that in some embodiments, a surface of some of the elements may be convex or concave. It is contemplated that the surfaces may be curved, as opposed to being generally flat.

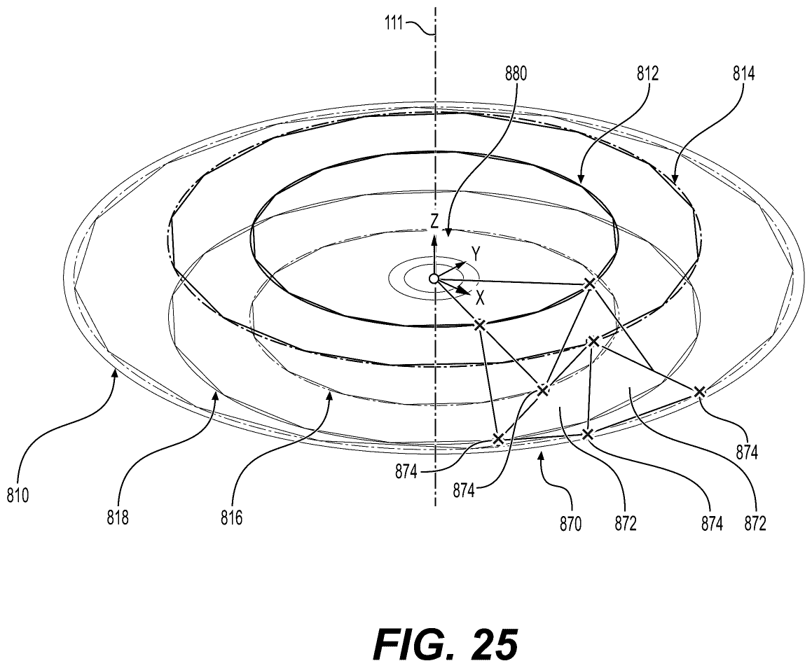

With reference to FIG. 25, there is depicted a visual output of the computer system 600 during the design process. The visual output shows an alternate set of orbits, namely orbits 810, 812, 814, 816, 818, and a cluster 870 of elements 872 having vertices 874 positioned on one of the orbits 810, 812, 814, 816, 818. It will be appreciated that the elements 872 may be representative of elements 130, and that the cluster 870 may be analogous to the inner and outer clusters 132, 134. The visual output also shown a coordinate system 880 in 3D space displayed to the human operator.

It will be appreciated that the computer system 600 can, upon generating the cluster 870, generate the resilient portion 130 by rotating and reproducing cluster 870 at given degrees intervals about the axis 111, where the totality of reproduced clusters 870 would form a corresponding resilient portion.

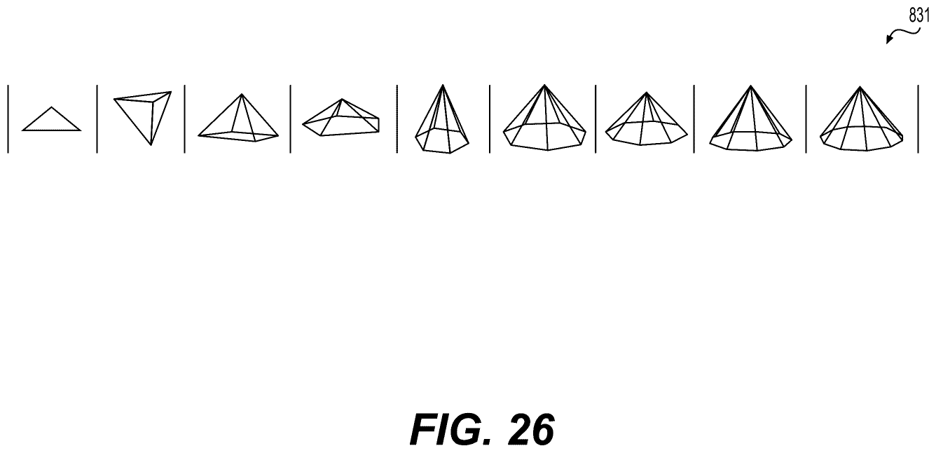

With reference to FIG. 26, there is depicted a table 831 illustrating some pyramidal shapes that the computer system 600 can generate based on a combination of elements having vertices positioned along the orbits 810, 812, 814, 816, 818. For example, the computer system 600 may generate automatically, and/or in response to an input from the human operator, pyramidal shapes using a combination of elements. In some embodiments, it can be said that the human operator may provide an input to the computer system 600 indicative of positions of vertices along the orbits 810, 812, 814, 816, 818, where the vertices define a cluster of elements which, in combination, may have a pyramidal shape. For example, a given cluster of elements may form a pyramidal shape such as a diagonal pyramidal shape, triangular pyramidal shape, a square pyramidal shape, a pentagonal pyramidal shape, a hexagonal pyramidal shape, and the like. In some embodiments, the human operator may provide an input to the computer system 600 indicative of the pyramidal shape of a cluster of elements such that the computer system 600 can generate the position of vertices along the orbits of each element forming the cluster of elements. It is also contemplated that the computer system 600 may also generate automatically, and/or in response to an input from the human operator, pyramidal shapes using a combination of elements. It is further contemplated that other 3D shapes can be produced.

### Symmetrical Compliant Wheel

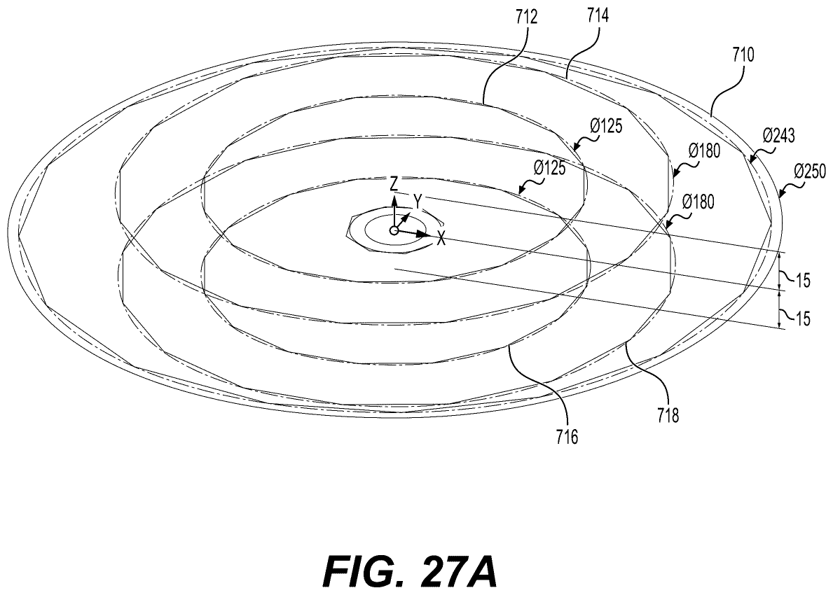

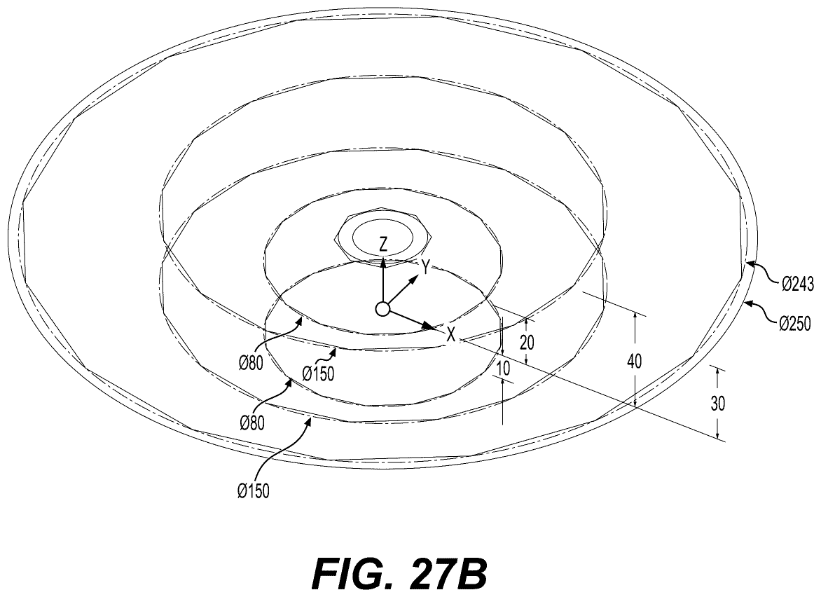

With reference to FIG. 27A, there is depicted a visual output of the orbits 810, 812, 814, 816, 818. The orbit 810 is generally aligned with the longitudinal plane (not shown) of the compliant wheel, the orbits 812, 814 are disposed on one side of the longitudinal plane, and the orbits 816, 818 are disposed on an other side of the longitudinal plane. Configuration parameters of the orbits 810, 812, 814, 816, 818 may be used to provide a given compliant wheel. The configuration parameters of the orbits 810, 812, 814, 816, 818 may be stored in the storage 602 of the computer system 600 and may be indicative of a total number of orbits, a number of inner orbits, a number of outer orbits, a diameter of a given orbit, a lateral distance between a given orbit and the longitudinal center plane.

In the illustrated embodiment, the orbits 712, 714 have respective diameters of about 125 mm, and about 180 mm. The orbits 716, 718 have respective diameters of about 125 mm, and about 180 mm. The central orbit 1213 has a diameter of about 243 mm. The lateral distance between the two orbits 712, 714 and the longitudinal plane is about 15 mm. The lateral distance between the two orbits 716, 718 and the longitudinal plane is also 15 mm (but on the opposite lateral side of the inner orbits). Other configurations are contemplated.

The compliant wheel 100 (shown in FIGS. 3A to 3D), the compliant wheel 200 (shown in FIGS. 8A to 8D), the compliant wheel 201 (shown in FIGS. 9A to 9D), the compliant wheel 202 (shown in FIGS. 10A to 10D), the compliant wheel 203 (shown in FIGS. 11A to 11D), and the compliant wheel 400 (shown in FIGS. 15A to 15D) can all be said to be designed in accordance with the present technology, and can be said to be “symmetrical” relative to the longitudinal plane 112. Symmetrical compliant wheels are designed using an inner set of orbits and an outer set of orbits, and where the inner set of orbits is symmetrical to the outer set of orbits relative to the longitudinal plane. It is contemplated that a given symmetrical compliant wheel may also have one or more central orbit extending in the longitudinal center plane. The compliant wheels are symmetrical compliant that have elements 130 disposed in different arrangements. A given pattern may be defined by a type and number of clusters of elements defined in a given resilient member. It is contemplated that the pattern of elements may depend on positions of respective vertices (including apexes) on the inner and outer orbits. Other patterns are contemplated.

### Asymmetrical Compliant Wheel

With reference to FIG. 27B, there is depicted a visual output of the orbits 810, 812, 814, 816, 818. The orbit 810 is generally aligned with the longitudinal plane (not shown) of the compliant wheel, the orbits 812, 814 are disposed on one side of the longitudinal plane, and the orbits 816, 818 are disposed on an other side of the longitudinal plane. Configuration parameters of the orbits 810, 812, 814, 816, 818 may be used to provide a given compliant wheel. Configuration parameters of the orbits 810, 812, 814, 816, 818 may be stored in the storage 302 of the computer system 600 and may be indicative of, inter alia, a total number of orbits, a number of inner orbits, a number of outer orbits, a diameter of a given orbit, a lateral distance between a given orbit and the longitudinal center plane.

In the illustrated embodiment, the orbits 810, 812, 814, 816, 818 have diameters of, respectively, about 243 mm, about 80 mm, about 180 mm, about 80 mm, and about 180 mm. The respective lateral distances between the orbits 812, 814, 816, 818 and the longitudinal center plane is about 10 mm, about 30 mm, about 20 mm and about 40 mm. Other configurations are contemplated.

The compliant wheels 204, 205 (shown in FIGS. 12A to 12E) can all be said to be designed in accordance with the present technology, and can be said to be “asymmetrical” relative to the longitudinal plane 112. Asymmetrical compliant wheels are designed using an inner set of orbits and an outer set of orbits, and where the inner set of orbits is not symmetrical to the outer set of orbits relative to the longitudinal plane. For example, orbits from the inner set comprise a different number of orbits than the outer set. In another example, orbits from the inner set may be located at different distances from the longitudinal plane than the distances between the corresponding orbits from the outer set and the longitudinal plane. In some embodiments of asymmetrical wheels, one or more of the orbits 810, 812, 814, 816, 818 may have the same size, but may be at different lateral distances from the longitudinal plane. It is contemplated that an asymmetrical compliant wheel may increase shock absorption properties of track systems during operation thereof.

As mentioned above, asymmetrical compliant wheels may undergo “side shift”. Broadly, when an asymmetrical compliant wheel resiliently deforms during operation, one side of the surface of the compliant wheel may shift laterally in comparison to when it is at rest, and thereby contact a laterally offset portion of the inner surface of the endless track.

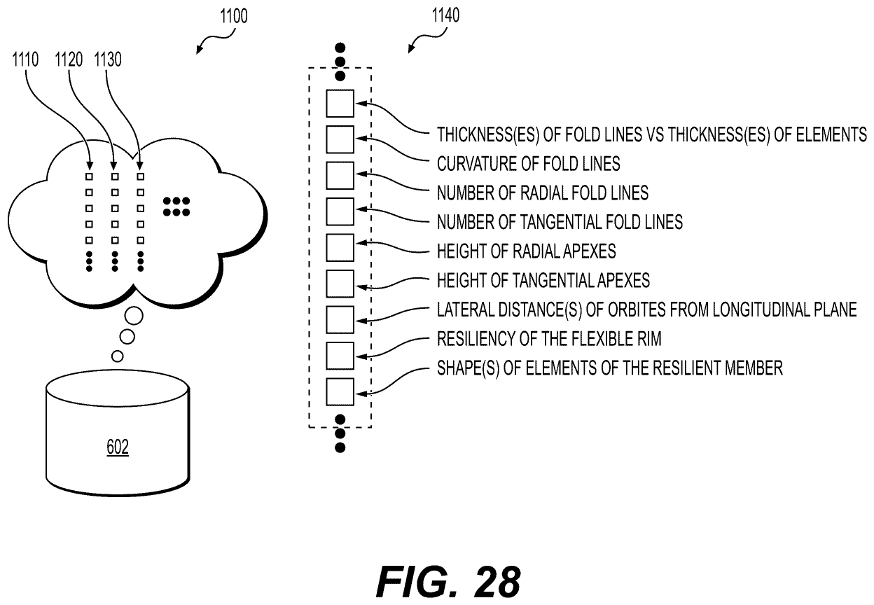

With reference to FIG. 28, there is depicted the storage 602 storing a plurality of data items 1100 associated with compliant wheels. For example, the storage 602 stores a first data item 1110 associated with a first compliant wheel, a second data item 1120 associated with a second compliant wheel, a third data item 1130 associated with a third compliant wheel, and a fourth data item 1140 associated with a fourth compliant wheel. It should be noted that a given data item may be in a form of one or more digital files that in combination allow generating a 3D representation of a corresponding compliant wheel.

It should also be noted that the fourth digital item 1140 is indicative of, inter alia, a list of factors or parameters that can affect the resiliency profile of the fourth compliant wheel. It should be noted however, that the illustrated list of factors is non-exhaustive, meaning that other parameters may be used to affect the profile of resiliency of the fourth compliant wheel, without departing from the scope of the present technology. In other embodiments, however, only a subset of factors may be used to vary the profile of resiliency of the fourth compliant wheel.

The fourth digital item 1140 includes: thickness of fold lines, thickness of elements, curvature of fold lines, number of radial and tangential fold lines, size of radial and tangential apexes, lateral distances between orbits, resiliency of the flexible rim portion, shape of the elements.

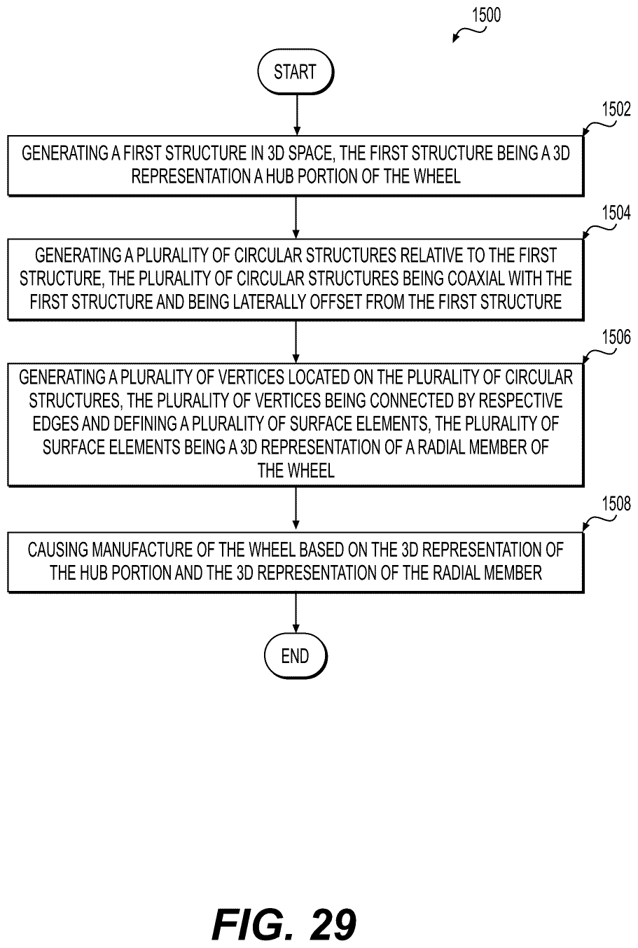

With reference to FIG. 29, a scheme-block representation of a method 1500 for generating a 3D representation of a given compliant wheel. For example, the method 1500 may be executed by the processor 620 of the computer system 600. Various steps of the method 1500 will now be discussed, however, it should be noted that the method 1500 may include additional steps to those illustrated in FIG. 29, without departing from the scope of the present technology.

Step 1502: Generating a First Structure in 3D Space, the First Structure being a 3D Representation a Hub Portion of the Wheel

The method 1500 begins at step 1502 with the processor 620 being configured to generate a first structure in 3D space. The first structure is a representation of a given hub portion of a given compliant wheel.

For example, the computer system 600 may generate a structure representing a hub portion passing through a longitudinal plane. The 3D structure representing the hub portion may be in a form of a hollow cylinder. The dimensions of the hub portion may be pre-determined and may vary based on inter alia different implementations of the present technology. It is contemplated that the computer system 600 may be configured to execute an appropriate 3D modeling software for generating 3D structures in accordance with some embodiments of the present technology.

Step 1504: Generating a Plurality of Circular Structures Relative to the First Structure, the Plurality of Circular Structures being Coaxial with the First Structure and being Laterally Offset from the First Structure

The method 1500 continues to step 1504 with the processor being configured to generate a plurality of circular structures relative to the first structure. For example, the computer system 600 may be configured to generate a plurality of structures representing orbits. It is contemplated that the plurality of circular structures generated by the processor are coaxially aligned with the first structure (e.g., 3D representation of the hub portion).

In some embodiments, the processor may generate circular structures with different diameters. It is contemplated that at least some of the circular structures generated by the processor are laterally spaced from the first structure.

In one embodiment, the processor may generate three circular structures located on one side of the first structure (e.g., inner side) and three other circular structures on the other side of the first structure (e.g., outer side).

It will be noted that these circular structures are design-oriented structures used during the design process for positioning vertices of the compliant wheel, and they are not structures that will be part of the final generated compliant wheel.

Step 1506: Generating a Plurality of Vertices Located on the Plurality of Circular Structures, the Plurality of Vertices being Connected by Respective Edges and Defining a Plurality of Surface Elements, the Plurality of Surface Elements being a 3D Representation of a Radial Member of the Wheel

The method 1500 continues to step 1506 with the processor configured to generate a plurality of vertices located on the plurality of circular structures.

As described above, the processor may generate three or more vertices V1a, V2a, and V3a. The vertex V1a is positioned along the one orbit, the vertex V2a is positioned along an other orbit 3, and the vertex V3a is positioned along another orbit 4. The position of vertices V1a, V2a, and V3a may be used by the processor for generating a triangular element. The processor may further generate three other vertices V1b, V2b, and V3b. In this embodiment, the vertices V1b, V2b, V3b are positioned along other or same orbits. The position of vertices V1b, V2b, and V3b may be used by the processor for generating another triangular element. It should be noted that the two triangular elements may share a common edge.

It is contemplated that more than one vertex of a given element may be positioned on a same orbit. As mentioned above, the processor may so-generate a plurality of surface elements of different shapes, and sizes which together form a 3D representation of a radial member of the wheel.

In some embodiments, at least some surface elements generated by the processor may be generally flat and may extend along a first plane in 3D space. For example, the triangular element “a” has a generally flat surface. Similarly, a second surface may be generally flat and extends along a second plane in 3D space. For example, the triangular element “b” has a generally flat surface. The first plane is at an angle relative to the second plane. In other embodiments, the processor may be configured to generate curved surface elements, as opposed to generally flat surface elements, and without departing from the scope of the present technology.

As such, the processor may be configured to generate a plurality of surface elements that share common edges amongst each other and which together form a 3D representation of a radial member of the compliant wheel. In some embodiments, these elements may be arranged by a mesh pattern.

### Step 1508: Causing Manufacture of the Wheel Based on the 3D Representation of the Hub Portion and the 3D Representation of the Radial Member

The method 1500 continues to step 1508 with the processor configured to cause manufacture of the 3D representation of the hub portion and the 3D representation of the radial member. In some embodiments, the processor may be configured to transmit instructions to a remote 3D printing system. However, other manufacturing techniques based on the 3D representation of the hub portion and of the 3D representation of the radial member are also contemplated.

In some embodiments, the resilient member may be made of a variety of materials, as described hereabove. It is contemplated that the resilient member may be made by an additive manufacturing process, such as molding, casting, injection, 3D-printing. In other embodiments, the resilient member may be pivotally connected to the hub portion.

The present disclosure has been described in the foregoing specification by means of non-restrictive illustrative embodiments provided as examples. These illustrative embodiments may be modified at will. The scope of the claims should not be limited by the embodiments set forth in the examples, but should be given the broadest interpretation consistent with the description as a whole.

1. A compliant wheel comprising:
a hub portion defining an axis and a longitudinal plane; and
a resilient portion extending radially from the hub portion, the resilient portion including:
a plurality of elements,
a plurality of fold lines, and
a first element of the plurality of elements and a second element of the plurality of elements being connected by one of the plurality of fold lines, the one of the plurality of fold lines defining a bend axis, the first element being configured to resiliently move relative to the second element about the bend axis.

2. The wheel of claim 1, wherein a force applied to the compliant wheel is distributed to at least some of the plurality of elements according to a pre-determined profile of resiliency

3. The compliant wheel of claim 1, wherein one of the plurality of elements has an element thickness, one of the plurality of fold lines has a fold line thickness, the element thickness being different from the fold line thickness.

4. The compliant wheel of claim 1, wherein the plurality of fold lines includes a plurality of radial fold lines and a plurality of tangent fold lines.

5. The compliant wheel of claim 1, wherein:
the plurality of elements defines at least one apex and at least one depression, the at least one apex and the at least one depression being connected by at least one of:
a radial fold line of the plurality of radial fold lines; and
a tangent fold line of the plurality of tangent fold lines.

6. The compliant wheel of claim 1, wherein the plurality of elements includes peripheral elements forming a peripheral surface of the compliant wheel.

7. The compliant wheel of claim 6, wherein the peripheral elements include a first peripheral element and a second peripheral element adjacent to the first peripheral element, the first and second peripheral elements extending at an angle to the longitudinal plane.

8. The compliant wheel of claim 1, further comprising a flexible rim portion connected to the resilient portion.

9. The compliant wheel of claim 1, wherein:
in a resting state, the compliant wheel has a first profile perimeter; and
in response to a force being applied to the compliant wheel, the compliant wheel deforms to a deformed state, in which:
at least some of the plurality of elements move about corresponding bend axes; and
the compliant wheel has a second profile perimeter, the second profile perimeter being substantially equal to the first profile perimeter.

10. The compliant wheel of claim 1, wherein:
the resilient portion defines a plurality of equal sections, each one of the plurality of sections comprising at least one peripheral segment;
in the resting state, a length of each peripheral segment of the plurality of peripheral segments is substantially similar; and
in the deformed state, a length of at least one of the peripheral segments varies.

11. The compliant wheel of claim 1, wherein:
the first element extends along a first plane;
the second element extends along a second plane; and
the second plane is at an angle relative to the first plane.

12. The compliant wheel of claim 1, wherein an inner profile of the resilient portion and an outer profile of the resilient portion are one of: asymmetrical relative to the longitudinal plane and symmetrical relative to the longitudinal plane.

13. The compliant wheel of claim 1, wherein at least one of the plurality of elements has a shape formed of at least three sides.

14. The compliant wheel of claim 13, wherein the first element has a first shape, the second element has a second shape, and the first and second shape are different from one another.

15. The wheel of claim 1, wherein at least some of the plurality of elements are arranged in a pyramidal clusters.

16. The compliant wheel of claim 1, wherein the first element and the second element are connected in a hinge configuration about the one of the plurality of fold lines.

17. A track system comprising:
a frame;
a plurality of wheel assemblies rotationally connected to the frame, at least one wheel assembly of the plurality of wheel assembly comprising the compliant wheel of claim 1; and
an endless track surrounding the frame, and the plurality of wheel assemblies.

18. A deformable wheel comprising:
a hub portion defining an axis and a longitudinal center plane; and
a resilient portion extending radially from the hub portion, the resilient portion including a plurality of elements arranged in a mesh pattern,
each one of the plurality of elements having a polygonal shape defining a plurality of vertices and a plurality of edges,
a first element and a second element being connected by one of the plurality of edges, the one of the plurality of edges defining a bend axis;
the first element being configured to resiliently move relative to the second element about the bend axis.

19. The deformable wheel of claim 18, wherein the resilient portion includes:
an inner side defining:
a first circle having a first diameter and defining a first plane axially spaced from the longitudinal center plane by a first distance;
a second circle having a second diameter and defining a second plane axially spaced from the longitudinal center plane by a second distance;
an outer side defining:
a third circle having a third diameter and defining a third plane axially spaced from the longitudinal center plane by a third distance;
a fourth circle having a fourth diameter and defining a fourth plane axially spaced from the longitudinal center plane by a fourth distance;
wherein the vertices of the first element are on at least three of the first, second, third and fourth circles.

20. The deformable wheel of claim 19, wherein at least one of:
the second diameter is greater than the first diameter; and
the third diameter is greater than the fourth diameter.
